(19) United States
(12) Patent Application Publication
(10) Pub. No.: US 2026/0151833 A1
(43) Pub. Date: Jun. 4, 2026

(54) POWDER DISTRIBUTION SYSTEM AND METHOD

(71) Applicant: Sakuu Corporation, San Jose, CA (US)

(72) Inventor: Siamak AZIZI, Los Gatos, CA (US)

(73) Assignee: Sakuu Corporation, San Jose, CA (US)

(21) Appl. No.: 19/202,209

(22) Filed: May 8, 2025

Related U.S. Application Data
(63) Continuation-in-part of application No. 18/966,015, filed on Dec. 2, 2024.

(51) Int. Cl. B22F 12/52; B22F 12/70; B29C 64/205; B33Y 10/00; B33Y 30/00; H01M 4/04

(52) U.S. Cl. CPC B22F 12/52; B22F 12/70; B29C 64/205; B33Y 10/00; B33Y 30/00; H01M 4/0416

(57) ABSTRACT

Systems, methods, and other embodiments associated with fluidization of powder within a funnel to facilitate high powder spreading rate and prevent powder bridging, accumulation, and agglomeration. In one embodiment, an apparatus includes a pair of movable surfaces, the pair of movable surfaces extending in the longitudinal direction, the pair of movable surfaces being positioned near an outlet of a funnel, and a gas delivery device positioned adjacent to an exterior surface of a movable surface of the pair of movable surfaces, the pair of movable surfaces are configured to uniformly distribute powder placed in the funnel across a surface of the pair of movable surfaces. The example apparatus may also include configuring the gas delivery device to deliver gas vertically from an outlet of the funnel towards an inlet of the funnel.

### CROSS REFERENCE TO THE RELATED APPLICATIONS

This application is related to the pending U.S. patent application Ser. No. 18/391,024, filed on Dec. 20, 2023, and entitled “Electrode Fabrication Process”, the entire contents of which are incorporated herein by reference.

### TECHNICAL FIELD

The embodiments generally relate to material deposition in additive manufacturing machines and systems, and more particularly, relates to apparatus, methods, and systems for obtaining controllable mass flow and uniform powder deposition while preventing blockage and mitigating segregation of powder deposited by using a powder distribution system and method.

### BACKGROUND

In typical material dispensers for additive manufacturing machines and systems, powder is placed into a feeder or a hopper of a powder distribution system and dispensed in parts or portions using an agitator and gravity. The powder distribution system may include an agitator attached to a surface of the hopper body to agitate particles or particulates of the powder placed within the hopper/feeder. However, the agitator tends to force powder out of the hopper/feeder sporadically making it challenging to control mass flow and powder segregation without requiring further processing of the powder. In some powder dispensing systems, the agitator may be arranged on an exterior surface of the hopper/feeder to help breakup powder near the outlet of the hopper thereby reducing blockage of the hopper outlet caused by accumulation and/or agglomeration of powder on the interior surfaces of the hopper. However, these powder dispensing systems fail to uniformly deposit powder onto a conveyor belt or substrate below the hopper. Generally, existing powder dispensing systems dispense or pour a loose powder material onto a substrate as a loose pile of powder of varying thickness that can contain surface imperfections, such as spots, valleys, holes, and so forth after being poured and initially spread. These powder layer imperfections and other non-uniformities, such as uneven thicknesses, in a battery electrode lead to poor battery performance and shortened cycle life and, therefore, must be removed.

Still, in some powder distribution systems a mechanical device or process such as a sieve or a movable shaft is added to the hopper to regulate or control dispensing of the powder onto a substrate or a conveyor belt. However, these mechanical devices and processes fail to improve the flow of powder deposition out of the hopper and fail to prevent powder accumulation and blockage within the hopper. Therefore, existing material dispensers can increase both time and costs for additive manufacturing machines and systems as they require frequent monitoring, adjustments, and calibration to facilitate controlled powder deposition and to remove or prevent powder blockage within the hopper/feeder. Thus, there is a need to provide an improved material dispenser to facilitate uniform powder deposition, mitigate powder segregation, resist powder blockage at the hopper outlet, and control powder mass flow.

### SUMMARY

In an implementation, an apparatus including a funnel, the funnel including at least one wall extending in a longitudinal direction; a movable surface, the movable surface positioned below the funnel and extending in the longitudinal direction beyond a distal end of the at least one wall; an exterior surface of the movable surface configured to include at least one groove; and wherein the funnel is centrally positioned between the distal ends of the movable surface to uniformly distribute powder placed in the funnel across a surface of the movable surface.

In another implementation, a method including depositing powder into a funnel, the funnel including at least one wall extending in a longitudinal direction; receiving deposited powder placed in the funnel by a movable surface, the movable surface positioned below the funnel and extending in the longitudinal direction beyond a distal end of the at least one wall; uniformly distributing powder placed in the funnel across a surface of the movable surface; moving the movable surface to move the deposited powder in the funnel away from the at least one wall of the funnel; and wherein an exterior surface of the movable surface is configured to include at least one groove.

In another implementation, a method of manufacturing dry powder (e.g., dry electrode powder) having active material particles, including mixing the active material particles with one or more conductive additives; mixing the active material particles with one or more binder materials; forming a coating on the active material particles comprising of binder materials and conductive additives; configuring binder material amounts to promote sufficient electrolyte penetration when the dry powder is subjected to compaction; and depositing the dry powder mixture into the conditioning funnel.

In another implementation, an apparatus including a pair of movable surfaces, the pair of movable surfaces extending in the longitudinal direction, the pair of movable surfaces being positioned near an outlet of a funnel; and a gas delivery device positioned adjacent to an exterior surface of a movable surface of the pair of movable surfaces; wherein the pair of movable surfaces are configured to uniformly distribute powder placed in the funnel across a surface of the pair of movable surfaces; and wherein the gas delivery device is configured to deliver gas vertically from an outlet of the funnel towards an inlet of the funnel.

In another implementation, a method including directing gas through a port of an enclosure, the port extending into a wall of the enclosure; delivering gas into the port, via one or more gas delivery devices, the gas delivery device and the port configured to deliver gas vertically from an outlet of a funnel towards the inlet of the funnel; and positioning at least one of a plurality of movable surfaces to be adjacent to the port, the exterior surface of the at least one movable surface being positioned between the ends of the port.

In another implementation, a conditioning unit including an enclosure having two opposing exterior walls; a gas delivery device positioned adjacent to an exterior wall; at least one exterior wall comprising a port, the port extending into a portion of the at least one exterior wall to direct gas or air from the gas delivery device; a pair of movable surfaces, the pair of movable surfaces extending in the longitudinal direction, the pair of movable surfaces being positioned between the two opposing exterior walls; wherein the pair of movable surfaces are configured to uniformly distribute powder placed across a surface of the pair of movable surfaces; and wherein the enclosure is positioned near an outlet of a funnel; and wherein the gas delivery device is configured to deliver gas vertically from the outlet of the funnel towards an inlet of the funnel.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1 illustrates one embodiment of a powder distribution system for obtaining controllable mass flow and uniform powder deposition while preventing blockage and mitigating segregation of powder deposited, in accordance with aspects of the present disclosure;

FIG. 2 illustrates one embodiment of a flowchart depicting a process for conditioning a powder material for placement into the powder distribution system of the present disclosure for facilitating controllable mass flow and uniform powder deposition while preventing blockage and mitigating segregation of powder deposited, in accordance with aspects of the present disclosure;

FIGS. 3A-3H illustrate example movable surfaces for transferring powder placed in the powder distribution system of FIG. 1, in accordance with aspects of the present disclosure;

FIGS. 4A-4B illustrate a cross-sectional side view of a distal end of the powder distribution system of FIG. 1 taken along the cutting plane A-A shown in FIG. 1 and including an example agitation device, in accordance with aspects of the present disclosure;

FIG. 5 illustrates a cross-sectional side view of an other distal end of the powder distribution system of FIG. 1 taken along the cutting plane A-A shown in FIG. 1 and including a shaft housing, an example shaft and shaft motor, in accordance with aspects of the present disclosure;

FIG. 6 illustrates a cross-sectional side view of the powder distribution system of FIG. 1 taken along the cutting plane B-B shown in FIG. 1, in accordance with aspects of the present disclosure;

FIGS. 7A-7C illustrate example splines that may be implemented with the powder distribution system of FIG. 1, in accordance with aspects of the present disclosure;

FIG. 8A illustrates an example powder mass flow gradient/distribution of a powder distribution system actuated with an agitation device directing actuation energy vertically towards an end of an operating movable surface;

FIG. 8B illustrates an example powder mass flow gradient/distribution of the powder distribution system of FIG. 1, the powder distribution system being actuated with an agitation device and having an operating movable surface, in accordance with aspects of the present disclosure;

FIG. 8C illustrates an example powder mass flow gradient/distribution of the powder distribution system of FIG. 1, the powder distribution system being actuated with an agitation device and having a stationary movable surface, in accordance with aspects of the present disclosure;

FIG. 8D illustrates an example mass flow gradient/distribution of the powder distribution system of FIG. 1, the powder distribution system not being actuated with an agitation device and having an operating movable surface, in accordance with aspects of the present disclosure;

FIG. 9 illustrates one embodiment of a flowchart depicting a process for facilitating controllable mass flow and uniform powder deposition while preventing blockage and mitigating segregation of powder deposited, in accordance with aspects of the present disclosure;

FIG. 10 illustrates one embodiment of an apparatus with multiple movable surfaces and a gas delivery system positioned adjacent to the outlet of the powder distribution system of FIG. 1, in accordance with aspects of the present disclosure;

FIGS. 11A-11B illustrate plan and perspective views of the example apparatus of FIG. 10, in accordance with aspects of the present disclosure;

FIG. 12 illustrates one embodiment of an apparatus with multiple movable surfaces and a gas delivery system positioned adjacent to the outlet of the powder distribution system of FIG. 1, in accordance with aspects of the present disclosure;

FIGS. 13A-13B illustrate plan and perspective views of the example apparatus of FIG. 12, in accordance with aspects of the present disclosure;

FIG. 14A-14C illustrate one embodiment of example gas delivery configurations for a gas delivery system, in accordance with aspects of the present disclosure; and

FIG. 15 illustrates one embodiment of a flowchart depicting a process for implementing an apparatus with multiple movable surfaces with a gas delivery system, in accordance with aspects of the present disclosure.

### DETAILED DESCRIPTION

Powder deposition for battery manufacturing typical involves depositing powder onto a conveyor or continuous substrate that transfers the powder through a series of spreading devices (e.g., smoothing, and conditioning rollers) that gradually compress the powder to obtain a desired thickness and smooth and uniform surface prior to a calendering stage. At the calendering stage, the compressed powder is compacted. A higher compaction rate translates to higher structural rigidity and density (e.g., higher battery capacity), and the higher the powder compression through spreading devices, while maintaining a smooth and uniform surface, the higher the compaction rate at the calendering stage. It follows then to measure each batch of deposited powder from a hopper or funnel for thickness and surface uniformity using common metrology tools and methods to determine the number of additional processing steps required to smooth and condition the powder for improved compaction at a calendering stage. Since non-uniformities in the powder surface and thickness require additional spreading devices and affect the performance of the calendering stage, it is desirable to rapidly control and minimize powder surface uniformity and thickness to reduce additional processing steps. At each spreading device the deposited powder undergoes a gradual compaction in preparation for a calendering stage to obtain a desired compaction rate of the powder layer. Therefore, powder surface and thickness uniformity and powder mass flow control is desired in each batch of deposited powder as non-uniformities in powder deposition require additional costs and time for processing non-uniform powder layers. For example, additional spreading devices and/or real-time adjustments to spreading devices (e.g., increasing or decreasing a smoothing or conditioning roller height) may be needed to obtain consistent and desired compaction rates at the calendering stage. The calender may be configured to apply at least one of pressure or heat to the powder to activate the binder and form, for example, a battery electrode.

In various embodiments and examples described herein, there are at least two separate mechanisms for promoting the flow of powder through the powder deposition system 100 comprising of shear flow and cavity flow. In shear flow, powder is made to flow due to shear force between the powder from the funnel 110 and the outer diameter (or exterior surfaces) of the movable surface 145. In cavity flow, powder is made to flow out of a cavity or groove of the movable surface 145. In shear flow, powder deposition can lead to sporadic or spotty dispensing. In cavity flow, powder deposition can lead to more consistent and linear flow compared to shear flow. However, to increase powder mass flow rate and consistently obtain a smooth and uniform thickness powder layer both these mechanisms, and others, may be tuned and used as desired. Therefore, it will readily be appreciated that one or both mechanisms may be utilized and tuned as needed to obtain controllable mass flow and uniform powder deposition while preventing blockage and mitigating segregation of powder deposited by using a powder distribution system and method as described herein.

### Powder Considerations

Additionally, the selection of powder materials and compositions are not restricted by the present disclosure, various materials, binders, and additives may be selected depending on the desired chemistry, application, and method of production. Some examples of powder compositions that may be utilized by the apparatus and method of the present disclosure are described in a related application by the Applicant (U.S. application Ser. No. 18/391,024), entitled “Electrode Fabrication Process,” filed on Dec. 20, 2023, and which is hereby incorporated by reference. The related application describes a method for manufacturing a battery electrode whereby dry particles are mixed with one or more electrode active materials, conductive additives, and one or more binder materials to form a binder-coated dry powder electrode material. The binder-coated dry powder electrode material can be used for a cathode or an anode. The dry powder electrode material is deposited onto an electrode current collector substrate using a dry powder dispensing device. In various examples described in the related application, the dry powder electrode material is a loose powder that can be poured at speed or mass rate from the dispensing device onto a moving current collector web in a roll-to-roll system. The dry powder electrode material remains loose on the current collector web after deposition as it travels towards a compaction stage. After being poured onto the current collector, the loose dry powder electrode material is uniformly spread across the width of the moving current collector web by one or more spreading devices. The one or more spreading devices may include a doctor blade, one or more counter-rotating smoothing rollers, and one or more forward-rotating conditioning rollers.

Working with loose dry powders on a moving web prior to compaction is not trivial. Thus, in various examples, the constituent materials of the loose dry powder electrode material are chosen to achieve a balance between flowability and cohesion. The flowability of the loose dry powder electrode material is tuned to allow these materials to readily pour from the dispensing device, yet not too flowable that it scatters upon hitting the moving web or is easily disturbed by the movement and associated vibration of the web. Additionally, an electrode layer must be smooth and uniform in thickness after compaction and a material that is too flowable does not compact well when calendered. Attempts to compact a highly flowable material with a calender often include streaks in the direction of the moving web as the flowable powder is pushed down the current collector web by the calender or the powder slips. Conversely, if the loose dry powder electrode material is too cohesive, it comes out of the powder dispenser in clumps, does not spread well, and does not create a smooth and uniform layer when calendered or spread (e.g., there is often separation between individual clumps). Thus, the constituent materials of the loose dry powder electrode material are chosen to achieve a balance between flowability and cohesion. The powder layer, whether used for an electrode of an anode or cathode, must be smooth and uniform in thickness to improve a compaction rate at a calendering stage. Moreover, the powder materials and composition and powder dispensing unit must be selected and configured for a roll-to-roll system, for example, to obtain uniform powder deposition across a width of the roll while resisting blockage and mitigating segregation of powder particles from the powder dispensing unit.

Previous powder dispensing systems provide powder deposition using a rotatable shaft coupled with a hopper that can typically result in unpredictable and inconsistent powder mass flow from the hopper and non-uniform powder deposition from the rotatable shaft due to problematic rotatable shaft geometry, hopper geometry, and actuation methods. One problem with previous powder dispensing systems includes hopper geometries that fail to facilitate fluidic flow of dry powder and can lead to ratholing of dry powder within the hopper. Another problem with previous powder dispensing systems includes inconsistent actuation methods that inhibit powder mass flow from the movable surface (e.g., rotatable shaft, conveyor belt, etc. ,) and leads to inconsistent powder mass flow and non-uniform powder layer onto a target substrate. Another problem with previous powder dispensing systems includes rotatable shaft or spline geometries that can fail to provide adequate cavity flow and shear flow for extended periods of time to obtain a powder layer deposited on a target substrate having a smooth and uniform thickness.

With the present distribution system, various implementations of rotatable shaft geometry, hopper geometry, and actuation methods are disclosed and implemented to improve and control dry powder mass flow, facilitated smooth and uniform thickness of deposited powder layer, and effectuate consistent deposition of a uniform powder layer over extended periods of time.

### Powder Deposition Apparatus

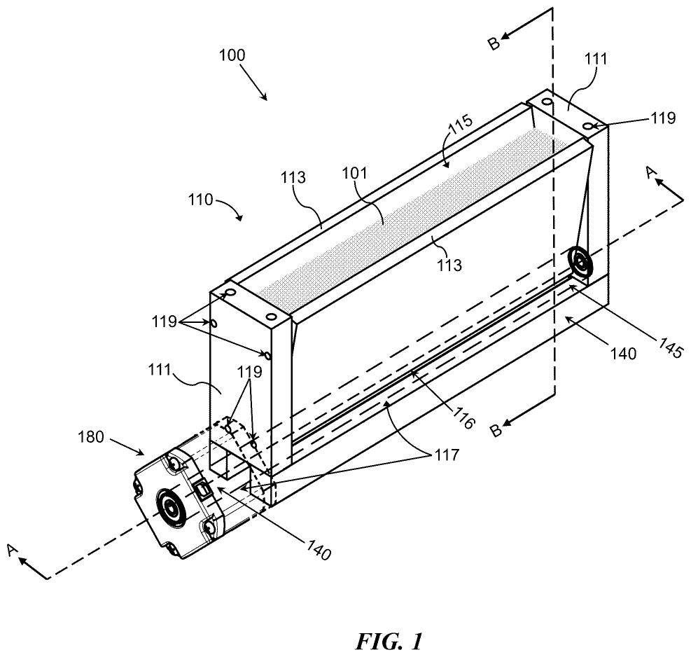

With reference to FIG. 1, one implementation of a powder distribution system is illustrated, the powder distribution system being configured for controlling speed or rate of powder mass flow and facilitating uniform powder deposition onto a conveyor or substrate while preventing blockage and mitigating segregation of powder to be deposited. As an example, the powder distribution system 100 may be configured to include a hopper or funnel 110, a dispensing unit 140 containing one or more movable surfaces 145, and a driving mechanism 180 for moving the one or more movable surfaces 145. The movable surface 145 may transport the deposited powder through at least one of a linear motion and a rotational motion. In various embodiments and examples described herein, there are at least two separate mechanisms for promoting the flow of powder through the powder deposition system 100 comprising of shear flow and cavity flow. In shear flow, powder is made to flow due to shear force between the powder from the funnel 110 and the outer diameter (or exterior surfaces) of the movable surface 145. In cavity flow, powder is made to flow out of a cavity or groove of the movable surface 145. In shear flow, powder deposition can lead to sporadic or spotty dispensing. In cavity flow, powder deposition can lead to more consistent and linear flow compared to shear flow. However, to increase powder mass flow rate and consistently obtain a smooth and uniform thickness powder layer both these mechanisms, and others, may be tuned and used as desired.

FIG. 1 illustrates an aspect and embodiment in which the powder distribution system 100 is configured to include a driving mechanism 180 for transferring powder 101 received by one or more movable surfaces 145 away from the funnel 110. In one implementation, the funnel 110 may include an inlet 115 for receiving particulate material (e.g., untreated or pre-treated powder) and an outlet 116 for dispensing particulate material away from the funnel 110. In some implementations, the inlet 115 may be substantially larger than an outlet 116. Further, the shape of an opening of the inlet 115 may be the same or different from the shape of the opening of the outlet 116. In some implementations, the opening of the inlet 115 may form a rectangular shape. As an example, the funnel 110 may include opposing walls 111, each opposing wall 111 being coupled to an adjacent wall 113 to form the opening of the inlet 115. Alternatively, the funnel 110 may be formed of a single unitary structure having (continuous or) integrally formed walls 111 and 113. In some embodiments, the geometry of the funnel 110 may be adjusted accordingly to facilitate dispensing of powder 101 and control of mass flow out of the funnel 110.

In a further aspect of the disclosure, one or more funnel walls 113 may be movably (or detachably) coupled to funnel walls 111 using one or more fasteners 119, whereby an angle of the walls 113 may be individually adjusted to extend diagonally in the vertical direction to facilitate fluidic dispensing of powder 101, for example. In some implementations, the geometry of the funnel walls 111 and 113 may be configured and adjusted to control powder mass flow, the flowability of powder 101 placed in funnel 110, and the level of shearing force applied to the powder 101 placed on a surface of the movable surface 145 adjacent to the funnel 110. For example, the length, width, and angle of each funnel wall 111, 113 extending from the opening in the inlet 115 to the opening in the outlet 116 may be adjusted as needed to control powder mass flow out from the funnel 110. In a further aspect of the disclosure, in some embodiments, the funnel 110 may be centrally positioned to between the ends of the movable surface 145 and at least one funnel wall 111 and 113 may be configured to extend in a longitudinal direction, for example, to uniformly distribute the powder 101 with the funnel 110 as powder leaves the outlet 116 of the funnel 110. In one embodiment, the funnel 110 and/or funnel walls 111 and 113 may include a heating pad on an exterior surface to facilitate flowability of the powder 101. In one implementation, a heating pad or heating device may be positioned away from the funnel surfaces, for example, in an interior space or an exterior space of the funnel 110 to fluidize the powder. Further, in certain implementations, a drying unit may be positioned away from the funnel surfaces, to facilitate fluidic flow of the powder. In some embodiments, the heating device and/or drying unit may facilitate control of the temperature and humidity within the funnel to fluidize powder 101.

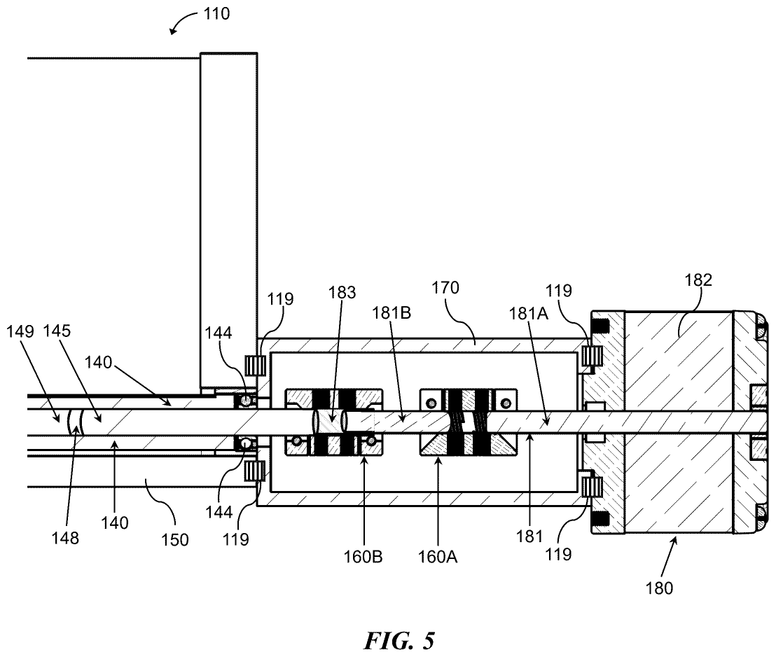

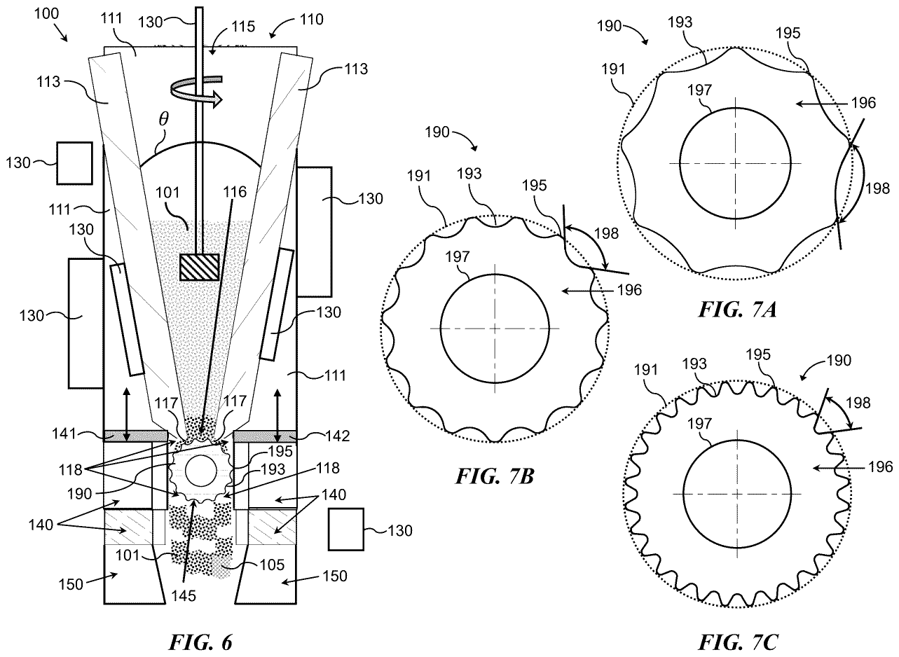

In some embodiments, each of the funnel walls 111 and 113 may be aligned or repositioned using fasteners 119 to adjust a level of cavity flow or shear flow for the powder at the outlet 116 of the funnel 110 to facilitate consistent mass flow and uniform distribution of powder away from the one or more movable surfaces 145. In one embodiment, at least one of the one or more movable surfaces 145, the funnel walls 111 and 113, and the powder dispensing unit 140 may be positioned to partition the outlet 116 into two or more openings to control, limit, or apply a shearing force to the powder 101 and provide consistent mass flow through openings or spaces 117. With reference to FIGS. 6 and 7A-7C, in certain embodiments, one or more surfaces (or regions) of each movable surface 145 may be configured to further partition the space between the outlet 116 into two or more cavities 118 as need to facilitate consistent mass flow and uniform distribution of powder 101 away from the one or more movable surfaces 145.

Further, in certain implementations, each of the funnel walls 111 and 113 may be individually angled to be between 0 degree to 180 degrees to the dispensing unit 140 or the one or more movable surfaces 145. For example, an angle between funnel walls 111 and 113 and the normal to the dispensing unit 140 or the one or more movable surfaces 145 may be in a range between 45 degrees to 135 degrees to facilitate fluidic flow of the powder 101. Further, at least one funnel wall 111, 113 may extend in the longitudinal direction, and the inlet 115 and outlet 116 may also extend in the longitudinal direction. Moreover, in some implementations, it will be readily appreciated that utilizing one or more movable surfaces 145 and configuring the geometry and interior surfaces of the funnel 110 near the outlet 116 can facilitate consistent mass flow of powder 101 from the powder distribution system 100 and a uniformly distributed powder layer onto a roll-to-roll system, conveyor belt, substrate, segmented substrate, continuous substrate, or the like without damaging the powder 101.

In other configurations, the opening of outlet 116 may be adjusted as described herein to facilitate fluidic flow of the deposited powder 101 and prevent powder agglomeration. Depending on powder material composition, the particles, or particulates of the powder 101 can tend to agglomerate leading to an undesirable effect of powder clumping at or near the movable surface which can reduce fluidic flow of the powder and can prevent uniform powder layer deposition leading to additional powder layer processing. Moreover, powder material composition and compaction force from a mass of the powder 101 within the funnel 110 can cause powder agglomeration at or near the outlet 116 of the funnel 110. In some embodiments, an actuated sieve mesh (not shown) may be placed above and/or below the funnel 110 to fluidize the powder and reduce powder agglomeration. Moreover, air jetting and mechanical actuation may be applied before or after the actuated sieve mesh to eliminate powder agglomeration.

In a further aspect of the disclosure, in some embodiments, the funnel walls 111 and 113 may be fastened to each other using fasteners 119. In other implementations, the funnel walls 111 and 113 may be joined together as one continuous structure to form the shape of the funnel 110. The opening of the outlet 116 may be adjusted by adjusting at least one of the funnel walls 111 and 113 (e.g., shape and surfaces of the funnel 110), the positioning of the dispensing unit 140, and the positioning of the one or more movable surfaces 145 to facilitate fluidic flow of the powder 101 through the funnel 110, walls 111 and 113, the dispensing unit 140, and the one or more movable surfaces 145, for example. In some implementations, at least one of the funnel walls 111 and 113 may include a curved or non-linear surface that gradually approaches a surface of the one or more movable surfaces 145. In one embodiment, at least one of the funnel walls 111 and 113 may form a curved surface that substantially matches the surface of the movable surface 145. In certain embodiments, at least one funnel walls 111 and 113 may bend towards the movable surfaces 145 gradually reducing one or more openings at the outlet 116.

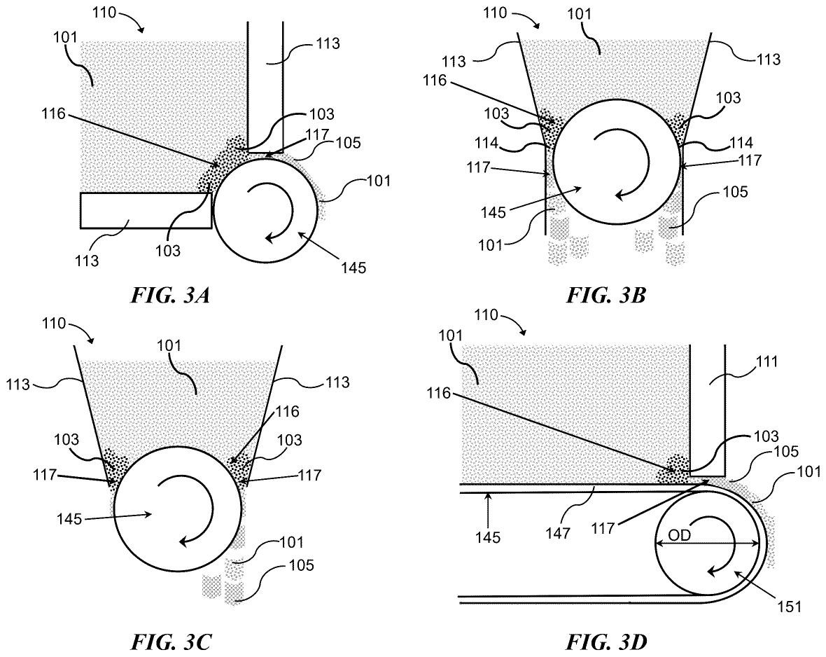

In a further aspect of the disclosure, the powder distribution system 100 may include a dispensing unit 140 configured to be fastened to the funnel or at least one of the funnel walls 111 and 113 and further configured to define a space 117 between the one or more movable surfaces 145 based on a predetermined geometry, surface, and dimensions. With reference to FIG. 3H, in one embodiment, the dispensing unit 140 may be configured as an enclosure that substantially encloses a moving surface 145 and extends vertically from the funnel 110 to define a space 117 above and below the moving surface 145. In one implementation, the dispensing unit 140 may be positioned within a space 117 directly below the funnel 110 in order to facilitate uniform deposition of powder 101 from the funnel 110 onto a substrate, conveyor belt, or the like, as an example. In a further aspect of the disclosure, the dispensing unit 140 may be configured to prohibit powder 101 from moving horizontally to facilitate uniform distribution of powder deposition vertically onto the substrate, for example. As an example, an exterior surface of the movable surface 145 may receive powder 101 and move the powder 101 through a linear or rotational motion against the funnel walls 111 and 113 and/or dispensing unit 140 to control a powder mass flow and/or apply a vertical or horizontal shear force to the powder 101 if needed, without damaging the powder 101, before vertically depositing the powder 101 onto a substrate, conveyor belt, or the like. Thus, the dispensing unit 140 can be configured to ensure powder 101 flows vertically and in between the outlet 116, the space 117, and the one or more movable surfaces 145.

Referring again to FIG. 1, in one implementation, the dispensing unit 140 may be configured to at least partially enclose space 117 between the one or more movable surfaces 145. In one configuration, the dispensing unit 140 may be detachably and/or movably coupled to the funnel walls 111 and 113 by one or more fasteners 119. Further, in many embodiments, the dispensing unit 140 may be positioned to enclose a space 117 between the one or more movable surfaces 145 and configured to prevent blockage of powder 101 at the outlet 116 while facilitating uniform deposition of powder mass flow across through the one or more movable surfaces 145. Moreover, in a further aspect of the disclosure, the one or more movable surfaces 145 and the dispensing unit 140 may be positioned to define the space 117 and facilitate consistent mass flow of powder away from the one or more movable surfaces 145.

With reference again to FIG. 1, the powder distribution system 100 may be configured to include a driving mechanism 180 for moving the one or more movable surfaces 145 in a linear motion or a rotational motion. In one implementation, at least one of the one or more movable surfaces 145 may include a rotational shaft, spine, roller, or rod whereby the driving mechanism 180 may include a single motor (not shown) driving each of the movable surfaces 145 in a rotational motion using a belt or chain drive. In one embodiment, the driving mechanism 180 may be secured to at least one of the funnel 110 and dispensing unit 140 using one or more fasteners 119. In one implementation, at least one of the one or more movable surfaces 145 may include a belt, segmented substrate, or conveyor belt, whereby each movable surface 145 can be individually driven with a single motor and gear drive (not shown). In many embodiments, each of the individual motors (e.g., servo motors) may be controlled with a controller (not shown). The controller may be configured to control other aspects of the powder distribution system 100, for example, actuation or agitation devices, rotational/linear speeds, temperatures of each movable surface 145, powder deposition rates into the funnel 110, and/or other system parameters. In some embodiments, two or more movable surfaces 145 may be implemented whereby each movable surface 145 may be controlled by a separate motor (not shown) that provides rotational motion (e.g., rotational shaft) or linear motion (e.g., conveyor belt).

The foregoing adjustments and configurations of the funnel walls 111 and 113 present a few examples for maintaining fluidic flow and cohesion of the powder 101 within the funnel 110 to facilitate deposition of a powder layer by the movable surface 145 having a smooth surface and uniform thickness. It is a further aspect of the disclosure to prevent powder 101 from accumulating or agglomerating in funnel 110 and blocking (existing or added) powder from flowing out of the funnel and onto a substrate. Moreover, it is an aspect of the disclosure to increase and control powder mass flow while ensuring consistency of the deposited powder layer, onto a continuous or moving substrate, over extended periods of time. In many embodiments, the powder distribution system 100 may be configured to obtain shear flow or cavity flow for the powder 101 by positioning the one or more movable surfaces 145, the funnel walls 111 and 113, the dispensing unit 140, the driving mechanism 180, or any combination thereof, as desired to obtain a predetermined distance, volume, or dimension for the space 117 to facilitate shear flow or cavity flow of the powder 101. The space 117 may have any suitable thickness, each space 117 may be configured to have the same or different dimensions (e.g., heights or widths). In various implementations, each space 117 may be defined with a height in a range from 0.10 mm to 5.00 mm. In one embodiment, each space 117 may be defined with a preferable height in a range from 1.00 mm to 2.50 mm. In one implementation, the powder distribution system 100 may be configured to exclude the movable surface 145 while implementing an actuated sieve mesh, described above, and one or more conditioning means (e.g., funnel agitation) to facilitate or maintain fluidic flow and prevent blockage of the powder 101. In one implementation, the powder distribution system 100 may be configured to exclude the dispensing unit 140 whereby fluidic flow of the powder may be facilitated by positioning of the funnel walls 111 and 113, the positioning of the movable surface 145, one or more actuated sieve meshes, one or more conditioning means, or any combinations thereof as described in FIGS. 3A-3H and FIG. 6.

### Method for Implementing Powder Engineering, and Powder Engineering for Distribution (Shearing Force: Range of Levels, Desired Powder Compression: Range of Levels)

In a further aspect of the disclosure, improvement in powder mass flow and uniform powder deposition from the powder distribution system 100 can be achieved by engineering powder materials and compositions and selecting powder distribution system 100 configurations that improve powder material cohesion and flowability based on the engineered powder material and composition. In various implementations, a morphology of a powder material can be tuned to improve flowability and cohesion of the powder material within the powder distribution system 100 described herein. Further, by distributing the powder material as a powder layer having smooth and uniform thickness, the powder distribution system 100 can improve cohesion and flowability of the corresponding powder layer deposited onto a roll-to-roll system. As described herein, in various implementations, the powder distribution system 100 facilitates improved compaction of the deposited powder layer prior to smoothing and conditioning rollers and a calendering stage in the roll-to-roll system.

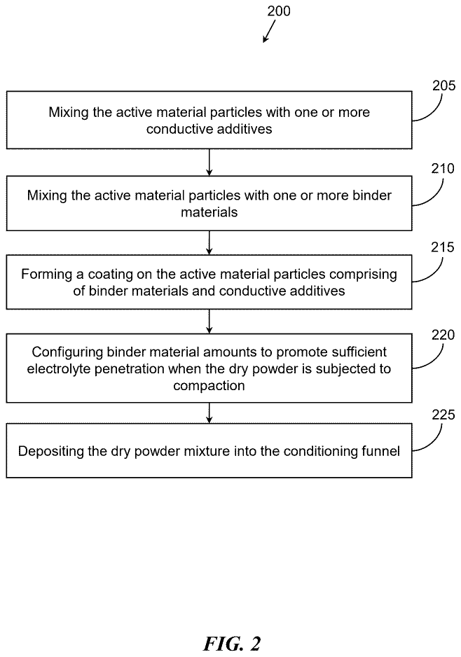

FIG. 2 illustrates an example flow chart showing a method of engineering powder for deposition to facilitate controllable mass flow and uniform powder deposition while preventing blockage and mitigating segregation of powder deposited, in accordance with one or more embodiments of the present disclosure. These exemplary methods are provided by way of example, as there are a variety of ways to carry out these methods. Each block shown in FIG. 2 represents one or more processes, methods, or subroutines, carried out in the exemplary method. FIGS. 1 and 3A-7C show example embodiments of carrying out the method of FIG. 2 for engineering powder for deposition to facilitate controllable mass flow and uniform powder deposition while preventing blockage and mitigating segregation of powder deposited. Each block shown in FIG. 2 represents one or more processes, methods, or subroutines, carried out in the exemplary method. The exemplary method may begin at block 201. Method 200 may be used independently or in combination with other methods or process for engineering powder for deposition to facilitate controllable mass flow and uniform powder deposition while preventing blockage and mitigating segregation of powder deposited. For explanatory purposes, the example process 200 is described herein with reference to the powder deposition system of FIGS. 1 and 3A-7C. Further for explanatory purposes, the blocks of the example process 200 are described herein as occurring in serial, or linearly. However, multiple blocks of the example process 200 may occur in parallel. In addition, the blocks of the example process 200 may be performed a different order than the order shown and/or one or more of the blocks of the example process 200 may not be performed. Further, any or all blocks of example process 200 may further be combined and done in parallel, in order, or out of order.

In FIG. 2, the exemplary method 200 of engineering powder for deposition to facilitate controllable mass flow and uniform powder deposition while preventing blockage and mitigating segregation of powder deposited is shown. Method 200 begins at block 205. In block 205, the method includes mixing the active material particles with one or more conductive additives. In block 210, the method includes mixing the active material particles with one or more binder materials. In block 215, the method includes forming a coating on the active material particles comprising of binder materials and conductive additives. In block 220, the method includes configuring binder material amounts to promote sufficient electrolyte penetration when the dry powder is subjected to compaction. In block 225, the method includes depositing the dry powder mixture into the conditioning funnel.

In one implementation, this method may be used to form electrode layers using active material particles to form an anode or cathode, using one or more conductive additives, and one or more binder materials may be mixed to form a dry powder electrode material. In one embodiment, the one or more binder materials include 0.5-2 wt % PVDF which is mixed with active material particles and conductive additives. In other embodiments, 2-4 wt % PVDF is used. The active material particles and one or more binder materials, in one embodiment, are dry mixed to achieve a partial coating of PVDF over the active material particles that is between 50 and 85%. Additionally, the dry particles are mixed for a duration and at shear forces sufficient to attach 70-100% percentage of fine binder particles onto the surface of the active material particles to achieve a D50 of 7-12 um to achieve a Hausner ratio between 1.3-1.45.

In various implementations, loose dry powder may be placed in the hopper or funnel 110. The dry powder may be produced by dry mixing particles of one or more active electrode materials, conductive additives, and one or more binder materials, constituent materials of the loose dry powder electrode material are chosen to achieve a balance between flowability and cohesion. Examples of dry powder materials used to form a cathode or anode may include, for example and not limited to, carbon black, activated carbon, graphite, graphene, carbon fiber, and carbon nanotubes, copper, aluminum, nickel, silver, pearl graphite, carbon-polymer composite, metal-polymer composite, or combinations thereof. Examples of anode active material include lithium, lithium powder, molten lithium, semi-liquid lithium, lithium titanium oxide, silicon, silicon oxide, hard carbon, and graphite or combinations thereof. Examples of cathode active material include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), lithium vanadium oxide (LVO), lithium iron disulfide, silver vanadium oxide, carbon monofluoride, copper oxide, sulfur, or combinations thereof. As an example, pearl graphite may be selected as a dry powder material for an anode formed by mixing an anode active material (e.g., graphite) with a conductive additive (e.g., conductive carbon) in a first mixing process. The pearl graphite may have sufficient flowability with a particle size of D50 in, for example, a range of 5-20 μm at ˜93 wt %. The conductive carbon, in this example, is 1.5 wt % with a particle size of D50 in the range of 1nm to <1 μm.

Any suitable mixing process may be used, and multiple mixing processes may be implemented. As an example, a dry powder anode material may be formed by mixing an anode active material (e.g., graphite) with a conductive additive (e.g., conductive carbon) in a first mixing process. In some embodiments, a second mixing process may be performed to mix the graphite/conductive carbon mixture with a binder, for example but not limited to, Polyvinylidene Fluoride (PVDF). In one embodiment, 0.5-5 wt% binder may be used in the mixing process. Alternatively, higher concentrations of 12 wt% binder may also be used. The resulting composite powder has improved dry powder flowability compared with other pure powder, such as NMC by itself.

In one embodiment, a small amount of solvent can be added during the mixing process as a process aid. The solvent may be removed during later stages of the mixing process or immediately after. The result is increased binding efficiency as a result of modifying the shape and structure of the binder. The solvent can be removed through mild heating (80° C.-160° C.), thus “locking in” a modified structure of the binder to create a dry active material powder. This dry active material powder can then be deposited onto a current collector, as an example.

[Full binder coat] In a further aspect of the disclosure, various example implementations of binder material(s) may be utilized in powder engineering a powder material for a desired flowability, cohesion, handleability, and other benefits as described herein. In one implementation, the morphology of a powder material includes coating an active material particle with a binder layer to improve flowability of the material particle. In one embodiment, the dry powder electrode material particle may include an active material particle coated with a binder layer (e.g., Polyvinylidene Fluoride (PVDF)). The binder layer may be produced by dry mixing active material, 0.50-20 wt % binder, and conductive additives. The binder layer may be used to coat, in part or in whole, the surface of active material particle to promote flowability. For example, a relatively higher concentration of binder in loose dry powder electrode material has been shown to result in a balance of flowability and cohesion when mixed using relatively higher shear forces.

[Partial binder coat] In certain embodiments, an example morphology of a dry powder electrode material particle may include a spherical active material particle, such as cathode active material NMC, with partial binder coating. In one embodiment, the partial binder coating may be produced by dry mixing active material, 2 wt % PVDF, and conductive additives at relatively lower shear forces. As an example, a partial binder coating may cover 60-70% of the surface of an active material particle. In some embodiments, partial binder coating may limit the PVDF to being a surface adherent to the active material particles after compaction and binder activation resulting in sufficient space (e.g., voids, cavities, etc. ,) between active material particles in the electrode layer for electrolyte penetration whereby flowability is improved but electrochemical properties are limited. In some embodiments, an example morphology of a dry powder electrode material particle may include an amorphous active material particle, such as cathode active material LFP, with partial binder coating.

[Porous binder coat] In some embodiments, an example morphology of a dry powder electrode material particle may include spherical active material particle, such as cathode active material NMC, with porous binder coating. Additionally, the resulting morphology, its porous nature, and spread of the binder layer result, in one embodiment, in an increase in ionic conductivity due to capillary forces that encourage electrolyte penetration toward and access to active material particle. In one embodiment, the porous binder coating may be a matrix of nano PVDF particles (200-500 nm in diameter). The matrix, in one embodiment, may appear as a porous hard-spongelike layer composed of many nano PVDF particles attached to each other surrounding active material particle and can range from areas of no coverage on the surface of active material particle to areas of multiple nano PVDF particles thick. In one embodiment, porous binder coating, may be produced by dry mixing the active material, 2 wt % nano PVDF, and conductive additives at low shear forces. As an example, powder material particles may have a 70-90% binder surface coverage of active material particle. In certain embodiments, an example morphology of a dry powder electrode material particle may include amorphous active material particle, such as cathode active material LFP, with porous binder coating.

In some embodiments, higher shear forces exerted in the mixing of particles can cause the binder (e.g., full binder coating or partial binder coating of the active material particle) to at least partially deform and mold to the surface of the active material particles. Conversely, the relatively lower shear forces may be exerted when mixing dry powder electrode material particle cause the nano PVDF particles (e.g., porous binder coating) to adhere to the surface of active material particle and to each other (to form a three-dimensional matrix of particles) without complete deformation. Accordingly, porous binder coating causes increased friction having a Hausner ratio of roughly 1.38-1.45 and, thus, dry powder electrode material particle with porous binder coating of the active material particle does not flow as well as dry powder electrode material particles with full binder coating or partial binder coating of the active material particle yet can have superior electrochemical properties.

[Hybrid binder coat] In various implementations, any suitable thermoplastic binder compositions other than PVDF binder may be used to produce the dry powder material. In some embodiments, a hybrid binder composition may be used to obtain a desired balance between flowability and cohesion of the dry powder to produce a uniform powder layer. In various implementations, the hybrid binder composition may comprise a thermoplastic binder and a thermally curable binder, a UV curable binder, or two or more UV curable compositions where each binder is cured by UV radiation at a wavelength different from each other. When a hybrid binder comprising one or more of thermoplastic binder, thermally curable binder and UV curable binder is used, one or more of the components of the hybrid binder can be selectively cured or partially cured at a curing station to improve the cohesion and handleability of the dry powder material layer to prevent breaking down of the first layer during flipping through turn rollers.

In one embodiment, the hybrid binder composition may comprise one or more B-stage binder compositions which are partially cured, i.e., in the B-stage state. In various implementations, one or more of the components of the hybrid binder composition can be selectively cured or partially cured to tune the flowability and cohesion of the dry powder during the dry powder mixing process as described above or during a dry powder electrode manufacturing process. In various implementations, a dry powder material manufacturing process may include any suitable lubricating agents including organic materials (e.g., organic solvents) and other materials added to water that may be used to improve the cohesion and uniform compaction of the dry powder material. The amount of lubrication agent applied to the dry powder electrode material can be less than 10 wt %, preferably less than 5 wt %. In another example, the lubricating agent can serve as an activation agent to activate binder curing.

[Other binders] In some embodiments, the binder coated powder may comprise one or more of organic binders or inorganic binders or combinations thereof. The organic binder can comprise either a thermally curable composition, UV curable composition, or a photocurable composition or combinations thereof. In some implementations, the binder may comprise a ceramic precursor, such as polycarbosilane or polysiloxane which can thermally react and become part of the printed object during the post-printing process, e.g., sintering. In various embodiments, the binder coated powder can be made by any of the various particle coating techniques including but not limited to dry mixing, solvent evaporation, spray coating including spray drying and spray congealing, air suspension coating (also termed as fluidized bed coating), pan coating, centrifugal extrusion and multi-orifice centrifugal process, and the like. In various implementations, spray drying may be applied to the particles of the powder to impart fluidity on the powder in addition to, or in lieu of, other powder engineering processes described herein.

[Binder selection and limitations] In various aspects of the disclosure, powder engineering may include selection and configuration of one or more binder materials to hold the particles in place to make a cohesive layer. In many embodiments, application of binder material(s) and binder material amounts may be limited to the contact points between particles thereby limiting the binder contact points to promote sufficient electrolyte penetration into the resulting compacted powder layer (e.g., in a post-calendered electrode layer). There are multiple factors that may encourage the morphology of a dry powder electrode. One factor is the appropriate amount of binder, excessive use of binder would fill an unnecessary volume between particles, yet inadequate use of binder would not ensure sufficient particle to particle adhesion. Another factor is binder particle size; selection of small particles may not congeal as readily as larger agglomerates when melted, causing the binder to remain a surface adherent (i.e., keeping the binder from filling in the cavities between particles). Another factor is mixing intensity or shear force; the shear forces need to be strong enough to enable the binder particles to adhere to the active material particle surface, but not too strong that they deform and melt together and fully coat the particle surface limiting electrolyte penetration. Another factor is calendering pressure and heat; too much pressure and the structure collapses. Accordingly, the resulting morphology of dry powder electrode is a porous structure that, in one embodiment, increases ionic conductivity due to capillary forces that encourage electrolyte penetration toward and access to the active material particle.

### Movable Surfaces for Shear and Uniform Powder Deposition (material: Substrate 147, Desired Powder Compression: Range of Levels)

As can be readily understood and appreciated, a powder distribution system for the engineered powder material(s) and compositions may also be configured and tuned to maintain and/or improve dry powder material flowability and cohesion to facilitate smooth and uniform thickness of a deposited powder layer. The dispensing means for the powder material is preferably configured to facilitate deposition of a powder layer having a smooth and uniform thickness prior to smoothing and conditioning rollers and compaction by a calendering stage. In various embodiments, the deposited loose powder layer benefits from progressive conditioning and/or progressive compaction where each smoothing roller and each conditioning roller facilitates a compaction stage that provides additional compaction to the powder layer. As described above, in various implementations, powder materials may be engineered as needed to obtain a balance between flowability and cohesion as well as meeting target electrochemical properties for battery performance. Additionally, the powder distribution system 100 may be configured to obtain a desired shearing force of the powder material and a powder mass flow that can facilitate improved flowability, prevent powder blockage and accumulation, maintain powder cohesion, and a smooth and uniform thickness of a resulting deposited powder layer. In one implementation, the powder material may be configured with sufficient flowability to be poured into a powder distribution system 100 and received at an exterior surface of the movable surface 145. Further, the powder material may be configured with sufficient cohesiveness to stay on the movable surface 145 until the movable surface 145 is operated. As an example, the powder material may be configured with sufficient flowability to flow only when sheer is applied by the one or more movable surfaces and not flow when the movable surface is stationary. Moreover, the powder material may be configured with sufficient flowability to be poured from a powder distribution system 100 and sufficient cohesiveness to prevent the powder material from spilling off the sides of a substrate. In various embodiments, the powder material may be a loose powder that remains loose on a moving substrate after being deposited. As an example, the powder material may be used to form a battery electrode layer (e.g., an anode layer and a cathode layer), however various other three-dimensional objects may be formed.

With reference to FIGS. 3A-3H, various implementations of example movable surfaces for transferring powder placed in the powder distribution system of FIG. 1 is illustrated. FIGS. 3A-3H illustrate an aspect and embodiment in which example movable surfaces are utilized and configured to provide controlled powder mass flow, uniform distribution of powder across a width of the movable surface, and uniform distribution of powder across a deposition area below the powder distribution system 100. FIGS. 3A-3H illustrate some of the aspects and embodiments of the disclosure whereby the powder distribution system 100 may be configured to: minimize blockage of powder flow within the funnel 110, control powder mass flow through outlet 116 and space 117, and facilitate uniform distribution of powder onto a substrate, belt, or conveyor below the powder distribution system 100 over extended periods of time. In many embodiments, powder 101 may accumulate in one or more regions 103 adjacent to the outlet 116 based on various parameters, for example, the outer diameter of the movable surface 145, rotational speed of the movable surface 145, the temperature of the movable surface 145, the surface area and geometry of the movable surface 145, the coating of the movable surface 145 and electrostatic properties (i.e., adherence) of powder 101 to a surface of the movable surface 145, the dimensions of an opening of space 117 and/or the proximity of the movable surface 145 to the outlet 116, effect of gravity on the powder 101, the chemistry and/or state of the powder 101, and other parameters. In some embodiments, the dispensing unit 140 and enclosure 150 may be excluded such that powder is not confined between the movable surface 145 and dispensing unit 140 and enclosure 150. In certain implementations, the positioning and geometry of the movable surface 145 and the funnel walls 111 and 113 can be used to define the level of confinement and shearing of the powder 101.

In various implementations, at least one of the movable surface 145 and the funnel 110 may be subjected to one or more conditioning means to improve and/or maintain powder mass flow, powder flowability, powder handleability (i.e., one or more powder processing to improve loose dry powder distribution and arrangement on a substrate), prevent powder blockage, powder accumulation, powder agglomeration, and maintain powder cohesion and powder layer deposition consistency over extended periods of time. In various implementations, the conditioning means may temporarily increase the flowability of the powder to its original characteristics when deposited by a feeder or mixer into the powder distribution system 100. Examples of conditioning means, may include but not be limited to, mechanical application (e.g., actuation of the movable surface or funnel to improve powder flowability), chemical application (e.g., partially or fully coating the movable surface or funnel with one or more non-stick layers or materials to prevent powder accumulation, agglomeration, or blockage in the funnel or on the movable surface), and thermal or thermodynamic application (e.g., powder material activation by heating to improve powder material cohesiveness, or heating or cooling of the movable surface or funnel to control environmental conditions of the powder distribution system (e.g., heating a powder material environment to eliminate humidity and prevent powder agglomeration)). Moreover, in various implementations, the positioning and geometry of the funnel walls 111 and 113 and movable surface 145 (e.g., surface contours, dimensions, etc. ,) within the powder distribution system 100 may be configured as desired to define the volume of the one or more regions 103 (i.e., the volume of accumulated powder 101) such that powder 101 can accumulate along the surface of the movable surface 145 while the movable surface 145 to facilitate a non-shearing flow. Further, in certain implementations, the powder accumulated on the movable surface 145 may be subjected to one or more conditioning means as described herein. Moreover, in some embodiments, the movable surface 145 may be configured to include one or more grooves, linings, recesses, and/or splines to tune the powder mass flow rate without application of a shearing force or conditioning means as described herein. Further, the material(s), compositions, and surface coatings of the funnel walls 111 and 113 and movable surface 145 may be selected as desired to obtain desirable surface friction, electrostatic properties, shear flow or cavity flow (e.g., shearing force on deposited powder by the movable surface, or deposition of powder accumulated in cavities of the movable surface as described in FIG. 6), and excellent wear properties for consistent powder mass flow and uniform powder deposition through extended periods of time. As an example, the movable surface 145 and funnel 110 material may include any one of aluminum, steel, hardened stainless steel, metal or steel alloys, and the like to improve wear properties of the movable surface 145 and funnel 110. Moreover, movable surface 145 and funnel 110 may include non-stick surface coatings, high heat, wear, corrosion, solvent/chemical resistance, and/or impact resistant coatings such as non-stick nitrides and tungsten carbides, hardened coatings, or any combinations thereof to improve fluidization of powder and improve wear properties of the movable surface 145 and funnel 110.

Further, in various implementations, the powder distribution system 100 may be configured to deposit the powder layer on a continuous substrate or a build substrate. In one embodiment, the substrate may be configured as a moving continuous substrate, for example, a moving current collector web whereby the build substrate is unwound by a first roller and rewound by a second roller. Examples of materials that may be used for the substrate may include, but not be limited to, aluminum, copper, lithium, cobalt, manganese, iron, nickel and the like, or any combinations thereof. Further, the substrate may include various treatments such as a primer layer or a mechanically roughened surface to increase friction between the deposited loose powder material and a moving substrate to increase cohesion, for example.

Referring to FIG. 3A, in one implementation, the funnel 110 may be configured such that a distal end of at least two opposing funnel walls 113 is positioned, as an example and not limited to, at 90 degrees from each other to allow powder 101, placed in the funnel 110, to facilitate fluidization of the received powder 101 from a mixer or feeder. In one embodiment, at least two opposing funnel walls 113 may be positioned such that an angle of between 20 degrees to 75 degrees is formed therebetween, for example. The funnel walls 113 may be angled and adjusted as needed based on the properties of the powder 101 received into the funnel 110 from the mixer or feeder. As an example, the angled funnel walls 113 may be adjusted to facilitate fluidic flow of the powder and/or maintain or temporarily increase the flowability of the powder 101 as needed for consistent powder mass flow rate and uniform deposition based on accumulated and sitting powder 101 in the funnel 110. In certain implementations, a distal end of the funnel walls 113 may be adjusted to limit or gradually subject the powder 101 to a shearing force within space 117. For example, powder 101 may be subjected to a shearing force within space 117 when being transferred away from the funnel outlet 116 by one or more movable surfaces 145.

In one implementation, a distal end of the funnel walls 113 may be adjusted to minimize blockage of powder 101 within the funnel 110 while accounting for shearing flow and non-shearing flow. In one implementation, the movable surface 145 may include a rotational shaft that can be configured to apply a shearing force to the powder 101 in the one or more regions 103 based on the geometry of the movable surface 145 and the dimensions of the space 117. The powder 101 may then be transferred away from the funnel 110 as a sheared powder 105. Further, the movable surface 145 and the dispensing unit 140 may be configured to confine the movement of the sheared powder 105. In one embodiment, the sheared powder 105 may be confined to move in a vertical direction away from the movable surface 145 to facilitate vertical deposition of the sheared powder 105 as a powder layer onto a still/standing or moving substrate or conveyor belt. In some embodiments, one or more funnel walls 113 may be adjusted to increase a dimension of space 117 and/or a diameter of the movable surface 145 (e.g., an outer diameter of a spline) may be decreased to minimize or limit shearing of powder 101 as desired.

Referring to FIG. 3B, in one implementation, the funnel 110 may be configured such that at least two opposing funnel walls 113 extend vertically as one or more curved, linear, or rectilinear surfaces or structures to promote powder mass flow rate, fluidize powder, or maintain fluidic properties of the powder. Further, in one embodiment, the movable surface 145 may be positioned, in part or in whole, within the funnel 110 and inside the outlet 116 in order to prohibit powder from freely moving through the funnel outlet 116. In certain implementations, the movable surface 145 may be a rotatable shaft utilized to move and deposit powder 101 and apply a shearing force to the powder 101 within space 117, as defined by the dimensions space 117, to deposit sheared powder 105. In one embodiment, the funnel 110 may include an interface 114 as defined by the geometry of the funnel walls 113. The interface 114 may be configured as a region between the outlet 116 and the space 117 and a spacing between the funnel wall 113 and the movable surface 145. The dimensions and positioning of the interface 114 may further define one or more regions 103 where powder 101 may accumulate prior to conditioning (e.g., being actuated, heated, etc. ,) by the movable surface 145. In some embodiments, one or more funnel walls 113 may be adjusted to increase a dimension of space 117 and interface 114 and/or a diameter of the movable surface 145 (e.g., an outer diameter of a spline) may be decreased to minimize or limit shearing of powder 101 as desired.

In certain implementations, the interface 114 may be pinched such that the difference in spacing between the movable surface 145 and the one or more funnel walls 113 substantially and suddenly decreases to promote a sudden application of a shearing force to the powder 101 against funnel wall 113 before the powder 101 enters the space 117. In certain embodiments, the interface 114 between the outlet 116 and space 117 may be smooth such that the difference in spacing between the movable surface 145 and one or more funnel walls 113 gradually decreases to gradually apply a shearing force to the powder 101. In one implementation, the interface 114 on one opposing funnel wall 113 is the same as the interface 114 on the other opposing funnel wall. In another implementation, the spacing and region between the movable surface 145 and opposing funnel walls 113 may have different sized interfaces 114. In various embodiments, each interface 114 may be configured to have the same or different dimensions (e.g., heights or widths). In various implementations, each interface 114 may be defined with a width in a range from 0.10 mm to 2.00 mm. In one embodiment, each interface 114 may be defined with a preferable width in a range from 1.00 mm to 2.50 mm. In one embodiment, a sheared powder 105 may be transferred away from the movable surface 145 in the direction of the motion. In some implementations, non-sheared powder 101 may be allowed to pass through space 117 in a region opposite the direction of motion of the movable surface 145. Further, in certain implementations, the movable surface 145 may be stopped or paused to allow powder 101 to freely flow through each space 117 formed between each funnel wall 113.

Referring to FIG. 3C, in one implementation, the funnel 110 may be configured such that one or more funnel walls 113 extend towards an upper surface of the movable surface 145 and the funnel outlet 116 encapsulates at least a portion of the circumference of the movable surface 145. In one implementation, the movable surface 145 may be configured to move intermittently allowing some powder 101 accumulated in the one or more regions 103 to freely flow between the space 117 on both sides of the funnel walls 113. In certain embodiments, one or more conditioning means, for example, agitation or heating may be applied to the movable surface 145.

In one embodiment, the movable surface 145 may be positioned centrally, in part or in whole, above the funnel 110 and the outlet 116 in order to promote powder flow along the direction of motion of the movable surface 145 to be applied a shearing force in the space 117 to obtain a sheared powder 105. In one implementation, the one or more movable surfaces 145 may be configured to nearly abut a distal end of the funnel wall 113 such that powder movement is prevented from freely flowing through the funnel walls 113. As an example, a linear or rotational movement of the movable surface 145 may allow the powder to flow through a gap formed between the walls 113 and the movable surface 145. In some embodiments, one or more funnel walls 113 may be adjusted to increase a dimension of space 117 and/or a diameter of the movable surface 145 (e.g., an outer diameter of a spline) may be decreased to minimize or limit shearing of powder 101 as desired.

Referring to FIG. 3D, in one implementation, the one or more movable surfaces 145 may be configured to have one or more surface features 147, including, grooves, a roughened surface, splines, cavities, tabs, or other recesses or cavities to receive powder 101 and move the powder in a longitudinal direction. The movable surface 145 may include at least one of a solid or rigid material, a flexible material, a semi-flexible material, or a pliable material. In certain embodiments, the movable surface 145 may be segmented as multiple partitions. In one implementation, the contours and perimeter of outlet 116 may be defined by one or more surface features 147 of the movable surface 145 and a distal end of one or more funnel walls 111 and 113. The movable surface 145 may apply a level of shearing force to the powder 101 that has accumulated in the one or more regions 103 as the powder 101 moves through the space 117. The level of shearing force applied to the powder 101 may be based on the contours and perimeter of the outlet 116, the geometry of the space 117, one or more surface features 147, and the speed of movement of the powder 101 on the substrate 147. The sheared powder 105 may then be deposited as a powder layer onto a final substrate (e.g., an aluminum foil), a continuous substrate, or conveyor. In some embodiments, one or more funnel walls 111 may be adjusted to increase a dimension of space 117 and/or an outer diameter OD of shaft 151 for moving the movable surface 145 (i.e., the outer diameter one or more rotational shafts) may be decreased to minimize or limit shearing of powder 101 as desired.

Referring to FIG. 3E, in one implementation, a distal end of one or more of the funnel walls 113 may be configured to curve along the surface of the movable surface 145 thereby increasing the dimensions (e.g., length, width, height) of the space 117 and increasing a shearing time or amount therebetween. In one implementation, the funnel walls 113 may be configured to be positioned adjacent to, and abut, the movable surface 145 thereby facilitating shear flow through a shearing force applied to the powder along surfaces of the distal ends of funnel wall 113 and exterior surfaces of the movable surface 145. As an example, in one implementation, a distal end of the curved funnel wall 113 may be configured to gradually curve towards the upper surface of the movable surface 145 thereby gradually reducing one or more dimensions (e.g., height) of the space 117 and gradually increasing a shearing force applied to the powder 101. As described above, the space 117 may be configured to apply a level of shearing force to obtain sheared powder 105. Alternatively, the space 117 may be adjusted to minimize the level of shearing force applied to the powder 101. Thus, the space 117 and distal funnel walls 113 may be configured as needed to facilitate cavity flow or shear flow to aid in and facilitate fluidic flow of the powder 101 contained in funnel 110 and accumulated within region 103. In some embodiments, one or more funnel walls 113 may be adjusted to increase a dimension of space 117 and/or an outer diameter of the movable surface 145 may be decreased to minimize or limit shearing of powder 101 as desired.

Referring to FIG. 3F, in one implementation, the funnel walls 113 may be configured to gradually curve inwards towards the movable surface 145 at or above the funnel outlet 116 thereby gradually reducing one or more spaces 117A and 117B on opposing sides of the movable surface 145 and gradually applying a shearing force to powder 101 within spaces 117A and 117B to facilitate fluidic powder flow. In one implementation, an exterior surface of the movable surface 145 may be configured as a spline 190 with a plurality of cavities 193A and 193B. In one implementation, each of an opposing side of the movable surface 145 may be configured to have the same or different dimensions to tune a shear flow and cavity flow of powder 101 away from the funnel 110 and movable surface 145. As an example, the regions 103A and 103B, interfaces 114A and 114B, spaces 117A and 117B, and cavities 193A and 193B may each have the same or different dimensions. In one embodiment, each interface 114A, 114B may be defined with a preferable width in a range from 0.50 mm to 3.00 mm. In one embodiment, each space 117A, 117B may be defined with a preferable width in a range from 1.00 mm to 2.50 mm. In one embodiment, each region 103A, 103B may be defined with a preferable width in a range from 1.00 mm to 5.00 mm. In one embodiment, the nominal dimensions of each cavity 193A, 193B may be defined in the range of . 1mm to 3 mm, the volume dispensed per rotation by the spline 190 may be configured to be between 0.10 cm³ to 10.00 cm³, and the volume dispensed per cavity by the spline 190 may be configured to be between 0.05 cm³ to 2.00 cm³.

Referring to FIG. 3G, in one implementation, the funnel walls 113 may be angled and the movable surface 145 may be positioned at a distance, for example in a range from 1.00 mm to 2.50 mm, from the funnel 110. The movable surface 145 may be formed by a sieve mesh 152 coupled to and agitated by an agitation device 130. The movable surface 145 (i.e., the sieve mesh) may be vertically, laterally, or longitudinally agitated, or any combinations thereof, by the agitation device 130. It is readily contemplated, that other surfaces, for example, porous, non-porous, roughened, smooth, and the like may be implemented in place of the sieve mesh to fluidize the powder 101 and facilitate a smooth surface and uniform thickness of the deposited powder layer. In various implementations, movable surface 145, for example, rotating surface(s) as shown in FIGS. 3A-3C and 3H, conveyed surface(s) as shown in FIG. 3D, or agitated surface(s) as shown in FIG. 3G may include a roughen surface with a peak to valley height of 1-50 um. In certain implementations, the roughened surface peak to valley height may preferably be defined in the range of 5-20 um. In some embodiments, the roughened surface peak to valley height may be defined in the range of 8-12 um. In some implementations, the roughened surface peak to valley height may be equal to the diameter of the powder particle. In certain embodiments, the powder 101 may bridge or accumulate in one or more regions 103 within funnel 110 whereby one or more conditioning means may be applied to the powder 101 to fluidize the powder. In one implementation, one or more conditioning means may be applied to the powder 101 through one or more agitation devices 130. As described herein, the agitation device 130 may include one or more conditioning units. For example, in one embodiment, the agitation device 130 may include or be replaced by a heating unit. As another example, in one embodiment, the agitation device 130 may include or be replaced by a drying unit. In some embodiments, the agitation device 130 may be replaced by sonic actuation (i.e., sonic frequencies 20 Hz to 40 kHz), or mechanical actuation such as with an eccentric motor or other vibration source. In many embodiments, the agitation device 130 may be placed on at least one of the funnel 110, funnel walls 113, and the movable surface 145.

Referring to FIG. 3H, in one implementation, the funnel 110 and funnel walls 113 may be configured to position powder 101 onto an upper surface of the movable surface 145 and into an upper surface of the dispensing unit 140 that houses (e.g., substantially encloses) a movable surface 145 near the funnel outlet 116. The dispensing unit 140 may confine powder 101 within an extended space 117 to apply a level of compression and shear force to the powder 101 as desired. In some embodiments, further conditioning means may be applied to the powder 101 through one or more conditioning units placed on the funnel 110 and/or the movable surface 145. The sheared powder 105 may then be moved along the direction of motion and dispensed from the dispensing unit 140. In some embodiments, a dispensing spacing DS1 or DS2 of the dispensing unit 140 may be adjusted to increase/decrease a dimension of space 117 and/or an outer diameter of the movable surface 145 may be decreased to minimize or limit shearing of powder 101 as desired. In some embodiments, the dispensing spacing DS1 or DS2 may be the same. In certain embodiments, the dispensing spacing DS1 or DS2 may be different. In various implementations, the dispensing spacing DS1 or DS2 may be defined to be in a range from 0.50 mm to 50.00 mm.

### Actuator for Powder Deposition Apparatus

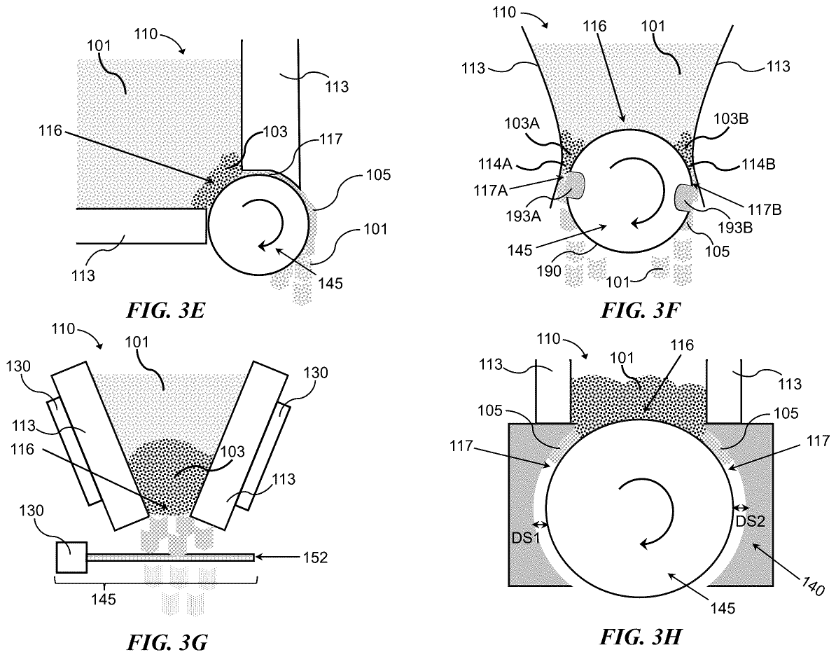

With reference to FIG. 4A, one implementation of an agitation device in the powder distribution system of FIG. 1 is illustrated. The example agitation device is illustrated in a cross-sectional side view of a distal end of the powder distribution system of FIG. 1 taken along the cutting plane A-A shown in FIG. 1, in accordance with aspects of the present disclosure. In various implementations, the powder distribution system 100 may include one or more mechanical actuation or agitation devices 130 coupled to the funnel 110 or movable surface 145. Each of the one or more agitation devices 130 may be added to the powder distribution system 100 and configured to increase and maintain consistent powder mass flow and powder layer deposition.

In some embodiments, the agitation device 130 may impart a conditioning effect to the powder 101 placed in the powder distribution system 100. In one implementation, the conditioning effect may temporarily increase the flowability of the powder by preventing agglomeration of powder and maintaining fluidic flow of the powder as when deposited by a feeder or mixer into the powder distribution system 100. In one embodiment, the agitation device 130 may dislodge any remaining powder 101 adhered to a surface of the funnel 110 or movable surface 145, for example, imparting movement to powder accumulated in region 103. Further, the agitation device 130 may be configured to push and displace powder off the movable surface 145 or the funnel 110 and towards the outlet 116 to facilitate additional powder mass flow. As an example, referring to FIGS. 7A-7D, a powder distribution system actuated with an agitation device as shown in FIGS. 7A-7C can exhibit greater powder mass flow. Whereas a powder distribution system not having actuation as shown in FIG. 7D may exhibit less powder mass flow.

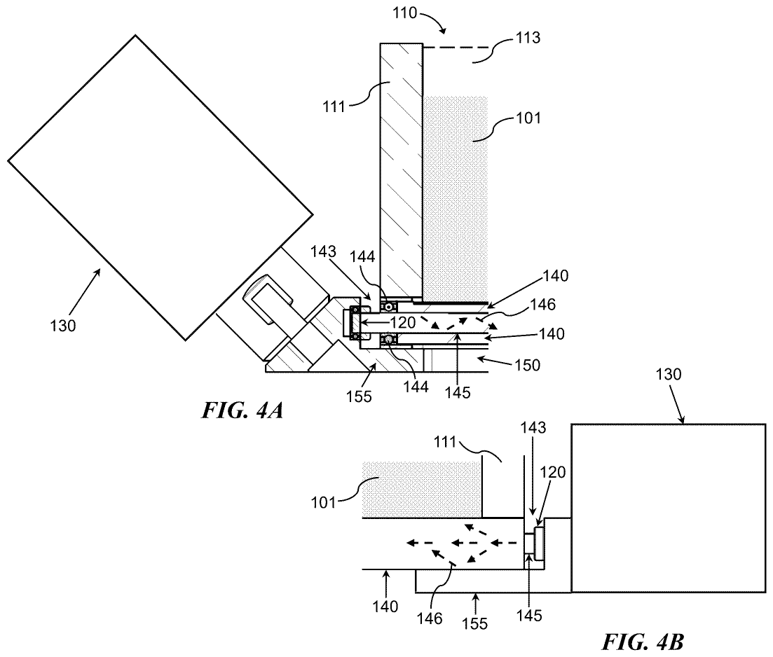

Referring again to FIG. 4A, in one implementation, a movable surface 145 may be configured as a rotational shaft. The rotational shaft may be rotatably coupled to a dispensing unit 140 through one or more rotational bearings 144 that maintain a vertical positioning of the movable surface 145 during rotation. Further, in one implementation, the dispensing unit 140 may be fastened or secured to one of more funnel walls 111 and 113. In one embodiment, the dispensing unit 140 may be movably attached to the funnel 110 to allow adjustments to the height of space 117 to control powder mass flow through outlet 116. For example, as shown in FIG. 5, the dispensing unit 140 may be attached to adjustable plates 142 that can increase or decrease the height of space 117.

In one implementation, an agitation device 130 may be movably coupled to the movable surface 145 to actuate the movable surface 145. In some embodiments, the agitation device 130 may be movably and directly mounted to mounting plate 155 and indirectly coupled to the movable device. In certain embodiments, the agitation device 130 may be movably mounted to the dispensing unit 140 and directly coupled to the movable surface 145 (e.g., a distal end of the movable surface 145). In one embodiment, the agitation device 130 may be movably and directly mounted to an enclosure 150, the enclosure 150 positioned beneath the movable surface 145 to further confine the deposited powder onto a substrate beneath the movable surface 145. Further, in certain embodiments, a clearance 143 may be provided between the movable surface 145 and the agitation device 130 to allow actuation energy to be distributed to the movable surface 145 while limiting application of excessive actuation energy to the funnel 110 or the movable surface 145 that can damage, for example, the rotational bearings 144, the motor 180, or other components of the powder distribution system. In various implementations, the clearance 143 may be defined with a length in a range from 0.10 mm to 5.00 mm. Further, a thrust bearing 120 may be included to dampen the transfer of actuation energy to the movable surface 145 and prevent damage to the rotational bearings 144. In one implementation, the thrust bearing 120 mates with a distal end of the rotational shaft opposite the agitation device 130 to dampen actuation energy and avoid metal to metal contact that can result in erratic actuation. Moreover, the mounting plate 155 may be slidably fixed or detachably attached to the dispensing unit 140 or the enclosure 150 to allow the clearance 143 and activation energy from agitation device 130 to be adjusted.

In one implementation, one or more agitation devices 130 may be mounted to at least one of the funnel 110 and the movable surface 145 to condition to the powder. In one embodiment, the agitation device 130 may be mounted at an angle in the range of between 30 degrees to 60 degrees normal to the longitudinal direction to adequately distribute actuation energy to the funnel 110 or the movable surface 145. In certain implementations, the agitation device 130 may be mounted at an angle in the range of between 30 degrees to 60 degrees normal to the lateral direction to adequately distribute actuation energy to the funnel 110 or the movable surface 145.

With reference to FIG. 4B, in one implementation, the agitation device 130 may be movably coupled to a distal end of the movable surface 140 to direct actuation energy longitudinally through at least the movable surface 145. In one embodiment, the agitation device 130 may be directly mounted to mounting plate 155 and coupled to the movable surface 145 through thrust bearing 120 as described herein. In one embodiment, the clearance 143 may be adjusted by a combination of a selection of a thrust bearing 120 having larger dimensions, for example, a greater thickness and positioning of the mounting plate 155 on the dispensing unit 140. In certain implementations, the agitation devices 130 may be mounted at any desired angle (e.g., in a range of 20-60 degrees) to direct actuation energy 146 directly through a medium and/or at angles through the medium to minimize aliasing or confinement of actuation energy to facilitate powder mass flow and minimize powder blockage in accumulation regions 103 (as shown in FIGS. 3A-3H). Moreover, the agitation devices 130 may be mounted at any desired angle to avoid creation of standing waves in the powder that can lead to segregation of large and small particles.

In various implementations, the agitation device 130 may include an ultrasonic module. In one embodiment, the ultrasonic module may be an ultrasonic transducer. Ultrasonic can substantially improve fluidization of the powder, for example, when the rotational shaft includes one or more grooves. In one embodiment, the ultrasonic transducer may be mounted directly to the spine shaft housing to reduce mechanical isolation between the ultrasonic transducer and the movable surface (e.g., rotatable shaft and its exterior surfaces). In some embodiments, the angle of mount of the ultrasonic transducer may be configured to distribute more or less ultrasonic wave energy to the funnel walls and body leading to powder fluidization and increased powder mass flow into the movable surface. Moreover, the amplitude and frequency (e.g., 20 kHz-50 kHz), 35 kHz preferred of the ultrasonic transducer may be configured to provide adequate and uniform ultrasonic wave energy throughout the movable surface and funnel walls and body to minimize uneven or excessive application of ultrasonic wave energy throughout the movable surface and the funnel walls and body. As an example, the ultrasonic transducer may be mounted at a 45-degree angle to a distal end of the movable surface, a distal end of the dispensing unit, or on a surface of the funnel wall to provide power transmission through and across surfaces thereby reduce aliasing (i.e., reduce confinement of ultrasonic waves within a vertical space). Further, the ultrasonic transducer may be configured to be impedance match with the material of the funnel wall, the dispensing unit, or the movable surface, as an example, for a selected Aluminum material movable surface, the frequency of the ultrasonic transducer may be 35 kHz to impedance match the aluminum body or surface of the movable surface. Moreover, in certain implementations, an amplitude of the ultrasonic transducer may be selected to distribute ultrasonic wave energy to the movable surface and the funnel that is sufficient to prevent cavity buildup of powder and ratholing within the funnel.

As can be readily appreciated, the ultrasonic transducer placement can aid in providing adequate and uniform ultrasonic wave energy throughout the movable surface and funnel walls and body. Thus, the ultrasonic transducer can be configured to fluidize the powder, prevent powder buildup, and minimize uneven or excessive application of ultrasonic wave energy that can lead to inconsistent powder mass flow for extended periods of application or time which is undesirable. Moreover, in certain implementations, ultrasonic actuation can be configured to facilitate consistent and uniform deposition of a powder layer across a width of a substrate by fluidization of powder on surfaces of the funnel and the movable surface.

In various implementations, further adjustments may be made to the ultrasonic transducer positioning. As an example, the ultrasonic transducer may be securely fastened to the dispensing unit or funnel walls or body to provide less deflection of ultrasonic wave energy. The ultrasonic wave energy may be applied directly attached to apply ultrasonic wave energy directly to the movable surface to facilitate consistent powder mass flow from the grooves and exterior surface(s) of the movable surface.

Additionally, other methods of fluidization of the powder (fluidization/conditioning units) can be used in place of ultrasonics such as gas injection (i.e., fluidized bed), sonic actuation (i.e., sonic frequencies 20 Hz to 40 kHz), or mechanical such as with an eccentric motor or other vibration source. Moreover, in many implementations, the movable surface 145 may provide the necessary force to fluidize and dispense the powder without agitation. As an example, in one implementation, the movable surface 145 can be configured as a smooth cylinder without features or grooves to facilitate fluidization of the powder. As will be described in more detail in FIGS. 6 and 7A-7C, in certain implementations, the geometry of the movable surface may be varied to provide the necessary force to fluidize and dispense the powder. For example, movable surface 145 may include one or more grooves having a smooth surface and uniform thickness that would be sufficient to fluidize and dispense the powder.

In many implementations, the agitation device 130 may be replaced by any other conditioning unit, one or more condition devices, and so forth. For example, the agitation device 130 may be replaced with a heating unit to heat and activate the powder material to improve powder material cohesiveness. In one example, the agitation device 130 may be replaced with a heating and/or cooling unit to heat or cool the movable surface or funnel to control environmental conditions of the powder distribution system, for example, heating the powder material environment to eliminate humidity and prevent powder agglomeration. In a further aspect of the disclosure, the agitation device 130 may include an actuation and heating unit to heat and agitate powder placed on the movable surface or in the funnel to improve powder flowability.

### Shaft Motor of Powder Deposition Apparatus

With reference to FIG. 5, one implementation of an example shaft housing, shaft, and shaft motor in the powder distribution system of FIG. 1 is illustrated. The example shaft housing, shaft and shaft motor is illustrated in a cross-sectional side view of an other distal end of the powder distribution system of FIG. 1 taken along the cutting plane A-A shown in FIG. 1, in accordance with aspects of the present disclosure. In various implementations, a powder distribution system 100 may include a movable surface 145 (e.g., a rotational shaft) coupled to a driving mechanism 180 (e.g., motor 182) through, for example, a shaft housing 170, a motor shaft 181, and couplings 160A and 160B. In one embodiment, the powder distribution system 100 may include a plurality of movable surfaces 145 (e.g., rotational shafts or conveyor belts) whereby each of the plurality of movable surfaces 145 may be configured to couple to a single driving mechanism 180. As an example, each of the plurality of movable surfaces 145 may be a rotational shaft, each rotational shaft being driven individually by a driving mechanism 180 in a rotational motion. Each coupling 160A and 160B may be selected as desired to obtain rigid or flexible clamping to facilitate dampening, axial alignment, torque transfer, or torsionally flexible coupling, as an example.

In one embodiment, a driving mechanism 180 may include a motor shaft 181 extending from an end of the driving mechanism 180 to movably couple with a movable surface 145. The motor shaft 181 may be a single piece comprising of a lower portion 181A and an upper portion 181B. In some embodiments, the motor shaft 181 may include two or more pieces as desired to uncouple or dampen motion, heat, or vibration transfer to the movable shaft 145, for example, if the motor shaft 181 is coupled to a conditioning device (e.g., agitation device, heating unit, etc. ,). The lower portion 181A of the motor shaft 181 may couple to coupling 160A and the upper portion 160B of the motor shaft 181 may couple to the movable surface 145 through coupling 160B such that the movable surface 145 may be freely or loosely coupled to the motor shaft 181 through couplings 160A and 160B. In certain implementations, a clearance 183 may be provided within coupling 160B between the movable surface 145 and the upper portion 181B of the motor shaft 181 such that the movable surface 145 may be conditioned (e.g., actuated or heated) without transferring conditioning (i.e., heat or agitation) to the driving mechanism 180 which can wear and damage the rotational couplings 144 and the driving mechanism 180 and/or components thereof.

In some embodiments, each coupling 160A and 160B may be made of different materials (e.g., aluminum, steel, stainless steel, or other metals and alloys) and selected based on a desired static torque rating, torsional rigidity, and dampening level to maintain alignment of the movable surface 145 and the motor shaft 181. Further, the positions for each coupling 160A and 160B along the motor shaft 181 and movable surface may be configured as desired to communicate accurate and consistent torque and rotational and/or linear speed and motion from the motor shaft 181 to the movable surface 145. As an example, coupling 160A may be a flexible beam/shaft coupler for connecting to a motor shaft of a servo motor, stepper motor, encoder, screw drives, or other machine, and coupling 160B may be a motor shaft to beam coupler for connecting a motor shaft to a movable surface. Moreover, the couplings 160A and 106B may be selected and configured to prevent undesirable motion, heat, or vibration transfer to the movable shaft 145 from the driving mechanism 180 to obtained consistent powder mass flow and uniform powder deposition over extended periods of time.

In one implementation, the driving mechanism 180 may be coupled to the funnel 110 using a shaft housing 170 using one or more fasteners 119. In certain implementations, the shaft housing 170 may be configured to further absorb and prevent undesirable motion, heat, or vibration transfer to the movable shaft 145 from the driving mechanism 180. In one embodiment, the driving mechanism 180 may be secured to at least one of the funnel 110 and the dispensing unit 140 using one or more fasteners 119. Referring to FIG. 1, in certain embodiments, the driving mechanism 180 may be directly secured to the funnel 110 so long as accurate and consistent torque and rotational and/or linear speed and motion from the motor shaft 181 to the movable surface 145 is maintained and undesirable motion, heat, or vibration transfer to the movable shaft 145 from the driving mechanism 180 is prevented or limited. In many implementations, the driving mechanism 180 and movable surface 145 may utilize various configurations as described herein, so long as a smooth surface and uniform thickness of the deposited powder layer is consistently maintained over extended periods of time.

With reference again to FIG. 5, at least one of the one or more movable surfaces 145 may include a rotational shaft, spine, roller, or rod whereby the driving mechanism 180 may include a single motor 182 driving each of the movable surfaces 145 in a rotational motion using a belt or chain drive. In one implementation, at least one of the one or more movable surfaces 145 may include a belt, segmented substrate, or conveyor belt, whereby each movable surface 145 can be individually driven with a single motor 182 and gear drive (not shown). In many embodiments, the driving mechanism 180 may include individual motors (e.g., servo motors) that may be controlled with a controller (not shown). The controller may be configured to control other aspects of the powder distribution system 100, for example, actuation or agitation devices, rotational/linear speeds, temperatures of each movable surface 145, powder deposition rates into the funnel 110, and/or other system parameters. In some embodiments, two or more movable surfaces 145 may be implemented whereby each movable surface 145 may be controlled by a separate motor (not shown) that provides rotational motion (e.g., rotational shaft) or linear motion (e.g., conveyor belt). In certain embodiments, the funnel 110 may include a dispensing unit 140 to confine the powder between the dispensing unit 140 and movable surface 145 and an enclosure 150 to further confine the powder and vertically directed powder deposition onto a continuous substrate, roll-to-roll system, or conveyor belt.

Further, in some embodiments, a powder distribution system 100 may include one or more couplers for coupling a plurality of movable surfaces arranged side by side between the funnel walls 111 and 113 for moving powder 101 away from the funnel 110. Referring again to FIG. 5, a second movable surface 149 (e.g., a rotational shaft) may be coupled to a first movable surface 145 by a coupler 148. The coupler 148 may be configured to include the same or different surface geometries (e.g., cavities, splines, etc. ,) as the first movable surface 145 and the second movable surface 149. Further, the second movable surface 149 may be configured to have the same or different surface geometries as the first movable surface 145 as described herein. Moreover, the coupler 148 may be configured to couple the second movable surface 149 to the first movable surface 145 such that the first and second movable surfaces 145, 149 move at the same speed. In one implementation, the second movable surface 149 may be coupled to a second motor (not shown) and/or a second conditioning unit (not shown) to be driven at a different speed and/or actuated at a different rate from the first movable surface 145.

### Hopper/Funnel of the Powder Deposition Apparatus

FIG. 6 illustrates a cross-sectional side view of the powder distribution system of FIG. 1 taken along the cutting plane B-B shown in FIG. 1, in accordance with aspects of the present disclosure. In a further aspect of the disclosure, in some embodiments, the powder deposition system 100 may include one or more conditioning units 121 and 123 positioned along (e.g., fixed, or detachably coupled to) an exterior surface of the funnel walls 111 and 113 to control an ambient environment, agitate interior and exterior surfaces of the funnel 101, agitate exterior surfaces of the movable surface 145, or any combination thereof, as an example. The funnel 110 may be configured to include a plurality of adjustable angled walls 111, 113 and an inlet 115 to receive and store powder 101 prior to transferring powder 101 to movable surface 145 through outlet 116. In a further aspect of the disclosure, and in many implementations, the adjustable funnel walls 111, 113 and one or more conditioning units 121 and 123 may be selectively positioned, activated, removed, or configured to fluidize powder 101 and facilitate increased powder mass flow and consistent powder deposition for extended periods of time. As described herein, the dispensing unit 140 and enclosure 150 may provide confinement of the powder 101 and control powder mass flow rate for vertically deposition of powder 101 onto a substrate. Further, the space 117 between the movable surface 145 and the funnel walls 113 may be adjusted using vertical adjustment plates 141 and 142 that can adjust a height of the space 117 to further provide confinement of the powder 101 and control powder mass flow rate. In certain implementations, the vertical adjustment plates 141 and 142 may be utilized to adjust the space 117 between the teeth 195 of the spline 190 and the distal ends of the funnel walls 113 to adjust the amount and level of shearing force applied to the powder 101. In certain implementations, the adjustment plates 141 and 142 may be configured to adjust a distance between the teeth 195 of the spline 190 and the distal ends of the funnel walls 113 to be defined in a preferable range from 0.50 mm to 4.50 mm. Moreover, an angle □ between the funnel walls 111 may be adjusted to provide sufficient powder flow for a desired powder mass flow deposition rate and to prevent powder accumulation and agglomeration within the funnel 110. In various implementations, the angle □ may be defined to be in a range from 0 degrees to 90 degrees. In one embodiment, the angle □ may be in a preferable range from 17 degrees to 27 degrees. Openings 118 facilitate cavity flow of powder 101 deposited in the cavities 193 of spline 190 of the movable surface 145. Space 117 between spine 190 of movable surface 145 and funnel walls 113 facilitate shear flow of powder 101 (sheared powder 105) deposited from the movable surface 145. The dispensing unit 140 and enclosure 150 may confine the powder deposition on a target substrate (e.g., continuous substrate). In certain implementations, the funnel 110 may include one or more agitation devices 130 to condition the powder 101. In one implementation, the funnel 110 may have one or no agitation devices 130 to condition the powder 101 by the geometry and positioning of the spline 190, funnel walls 111 and 113, movable surface 145, dispensing unit 140 and enclosure 150. Moreover, in some embodiments, the movable surface 145 may comprise of a smooth surface with no grooves and no surface features. In various implementations, the spline 190 geometry can promote better flow of powder from the cavities 193.

Referring again to FIG. 6, in some embodiments, one or more agitation devices 130 may be placed within funnel 110 to condition powder 101 accumulated in funnel 110. In one implementation, the agitation device 130 may include a rotating shaft with one or more blades for fluidization of powder 101 and preventing agglomeration of powder 101 accumulated in funnel 110. In certain implementations, the agitation device 130 may further include one or more actuation devices as described herein, for example, heating units, ultrasonic units, mechanical motors for acoustic agitation or vibration, and so forth.

### Example Splines for the Powder Deposition Apparatus

FIGS. 7A-7C illustrate example splines that may be used for various powder distribution system implementations as described herein. With reference to FIGS. 7A-7C, various embodiments of a geometry of a spline 190 that may be implemented with a powder distribution system includes a plurality of cavities 193 and teeth 195 are shown. In some implementations, the spine 190 may include an inner surface 196 and an inner diameter 197. In some implementations, the inner surface 196 material and the inner diameter 197 material may be made of the same material or made of different materials. In one embodiment, the inner diameter 197 may extend outwards from the exterior surfaces of the movable surface 145 to define a rod that may couple to or attach to a motor 180, an agitation device 130, or to an end of the body of the funnel 110. The spline 190 further includes an outer diameter 191. In various implementations, the inner diameter 197 may be defined in a range from 0.10 mm to 5.00 mm. In one embodiment, the inner diameter 197 may be defined with a preferable range from 1.00 mm to 2.50 mm. In various implementations, the outer diameter 191 may be defined in a range from 0.10 mm to 5.00 mm. In one embodiment, the outer diameter 191 may be defined with a preferable range from 1.00 mm to 2.50 mm. In one embodiment, the teeth 195 height may be defined with a preferable range from 0.20 mm to 3.50 mm. In various implementations, the nominal dimensions of the cavities 193 may be defined in the range of 0.1mm to 2 mm. Further, the volume dispensed per rotation by the spline 190 may be configured to be between 1.00 cm³ to 5.00 cm³. Moreover, the volume dispensed per cavity by the spline 190 may be configured to be between 0.10 cm³ to 1.00 cm³. Further, the pressure angle and profile angle of each spline cavity 193 may be adjusted to obtain smooth surfaces along the spline teeth 195. Moreover, in one embodiment, the cavity angle 198 may be defined with a preferable range from 30 degrees to 160 degrees. In one implementation, the spline 190 may be configured as a smooth spline with no cavities as shown in FIGS. 3A-3D, for example. A smooth spline can lead to shear powder flow, whereas more cavities can lead to greater shear flow or sporadic and spotty dispensing. Moreover, in certain implementations, a combination of the spline geometry and the amplitude of the ultrasonic transducer may facilitate improved powder mass flow through agitation, shearing force, and grooved pockets to carry additional powder away from the funnel. Examples of some spline geometries and dimensions that may be implemented with the powder deposition system 100 of the disclosure include:

A two-tooth resin printed spline (RPS) having 12.7 mm outer diameter, 2 mm tooth height, and 60-degree cavities.

Eight tooth spline, having 0.712 mm tooth height, 140-degree cavities, and 4.500 mm cavity radius of curvature.

Twelve tooth spline, having 6.350 mm outer diameter, 100-degree cavities, and 1.150 mm cavity radius of curvature.

Two tooth spline, having 1.000 mm tooth height, 6.350 mm outer diameter, 140-degree cavities, and 4.5 mm cavity radius of curvature.

Twenty-eight tooth spline, having 0.737 mm tooth height, 6.085 mm inner diameter, and 60-degree cavities.

### Actuated Powder Deposition Apparatus

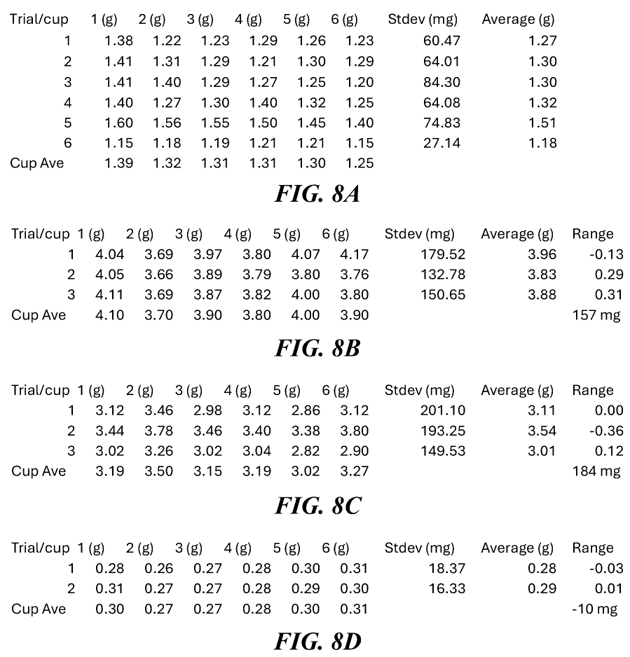

FIGS. 8A-8D illustrate sample powder mass flow gradient/distributions for some powder distribution system implementations as described herein. With reference to FIG. 8A, a sample powder mass flow gradient/distribution is shown for a powder distribution system with vertical actuation through an agitation device (e.g., ultrasonic transducer) that directs actuation energy vertically towards a distal end of an operating movable surface (e.g., a rotating shaft). FIG. 8A illustrates an example of consistent powder mass flow obtained from vertical actuation across a funnel body and shaft. However, the vertical actuation can limit powder mass flow as shown in FIG. 8B.

With reference to FIG. 8B, a sample powder mass flow gradient/distribution is shown for a powder distribution system with angled actuation through an agitation device (e.g., ultrasonic transducer) that directs actuation energy longitudinally from one distal end of an operating movable surface (e.g., a rotating shaft) to the other distal end. FIG. 8B illustrates an example of consistent and considerably greater powder mass flow obtained from operation of the movable surface and angled actuation longitudinally across an operating movable surface (e.g., a rotating shaft). Further, in the sample powder mass flow gradient/distribution of FIG. 8B, the mass flow gradient was determined to be independent of fluctuations in RPM of the rotating shaft, and consequently, reductions of ultrasonic amplitude led to reduction in overall powder mass flow, for example, when compared with FIG. 8A.

With reference to FIG. 8C, a sample powder mass flow gradient/distribution is shown for a powder distribution system with angled actuation through an agitation device (e.g., ultrasonic transducer) that directs actuation energy longitudinally from one distal end of a stationary movable surface (e.g., a rotating shaft) to the other distal end. FIG. 8C illustrates an example of consistent and greater powder mass flow obtained from a stationary movable surface and angled actuation longitudinally across an operating movable surface (e.g., a rotating shaft). Further, FIG. 8C illustrates ultrasonic actuation may facilitate controllable mass flow within a range, as expected. Whereas substantial, consistent, and uniform mass flow may be obtained through an operating movable surface (e.g., a rotating shaft).

With reference to FIG. 8D, a sample powder mass flow gradient/distribution is shown for a powder distribution system without actuation and an operating movable surface (e.g., a rotating shaft). FIG. 8D illustrates an example of consistent and uniform mass flow obtained from an operating movable surface (e.g., a rotating shaft) with no actuation on the movable surface. As described herein, in various implementations, the movable surface may be configured to improve powder mass flow while maintaining uniform powder deposition as a powder layer onto a substrate. For example, a shape of an exterior surface of a movable surface (e.g., rotating shaft) may be modified to facilitate uniform transfer of deposited powder away from the funnel, the shape being selected from the group consisting of a grooved wheel, a spline, and a gear, a smooth cylinder. Further, a vertical distance of the funnel to the movable surface may be adjusted to increase powder mass flow, for example.

Method for Implementing Powder Deposition

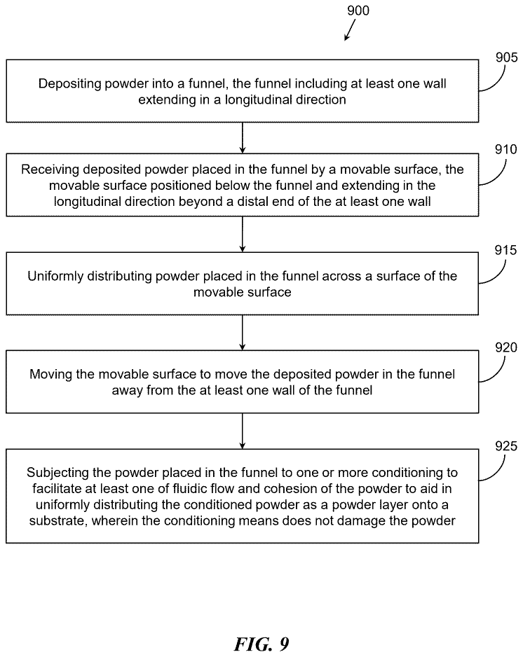

FIG. 9 illustrates an example flow chart showing a method of obtaining controllable mass flow and uniform powder deposition while preventing blockage and mitigating segregation of powder deposited, in accordance with one or more embodiments of the present disclosure. These exemplary methods are provided by way of example, as there are a variety of ways to carry out these methods. Each block shown in FIG. 9 represents one or more processes, methods, or subroutines, carried out in the exemplary method. FIGS. 1 and 3A-7C show example embodiments of carrying out the method of FIG. 9 for obtaining controllable mass flow and uniform powder deposition while preventing blockage and mitigating segregation of powder deposited. Each block shown in FIG. 9 represents one or more processes, methods, or subroutines, carried out in the exemplary method. The exemplary method may begin at block 901. Method 900 may be used independently or in combination with other methods or process for obtaining controllable mass flow and uniform powder deposition while preventing blockage and mitigating segregation of powder deposited. For explanatory purposes, the example process 900 is described herein with reference to the powder deposition system of FIGS. 1 and 3A-7C. Further for explanatory purposes, the blocks of the example process 900 are described herein as occurring in serial, or linearly. However, multiple blocks of the example process 900 may occur in parallel. In addition, the blocks of the example process 900 may be performed a different order than the order shown and/or one or more of the blocks of the example process 900 may not be performed. Further, any or all blocks of example process 900 may further be combined and done in parallel, in order, or out of order.

In FIG. 9, the exemplary method 900 of obtaining controllable mass flow and uniform powder deposition while preventing blockage and mitigating segregation of powder deposited is shown. Method 900 begins at block 905. In block 905, the method includes depositing powder into a funnel, the funnel including at least one wall extending in a longitudinal direction.

In block 910, the method includes receiving deposited powder placed in the funnel by a movable surface, the movable surface positioned below the funnel and extending in the longitudinal direction beyond a distal end of the at least one wall. In one embodiment, the method may further include coupling a housing to the movable surface, the housing providing the conditioning means by confining and shearing the powder between at least two of: the movable surface housing, the exterior surface of the movable surface, and the at least one groove of the movable surface.

In block 915, the method includes uniformly distributing powder placed in the funnel across a surface of the movable surface. In one embodiment, the method may further include an exterior surface of the movable surface being configured to include at least one groove to facilitate powder being uniformly distributed along the groove(s) and exterior surface(s) of the movable surface. Moreover, in certain implementations, the method may further include configuring a shaped of the exterior surface of the movable surface to facilitate uniform transfer of the powder away from the funnel, the shape being selected from the group consisting of a grooved wheel, a spline, a gear, and a smooth cylinder.

In block 920, the method includes moving the movable surface to move the deposited powder in the funnel away from the at least one wall of the funnel. In one embodiment, the method may further include actuating at least one of the funnel and the movable surface as a powder conditioning means to aid in uniform distribution of powder, the actuation being configured to be applied at an angle, the angle being configured to be between 30 degrees to 60 degrees normal to the longitudinal direction. In certain embodiments, the method may further include actuating at least one of the funnel and the movable surface as a powder conditioning means to aid in uniform distribution of powder, the actuation configured to be applied at an angle, the angle being configured to be between 30 degrees to 60 degrees normal to a lateral direction.

In block 925, the method includes subjecting the powder placed in the funnel to one or more conditioning to facilitate at least one of fluidic flow, preventing powder blockage, and preventing powder accumulation or agglomeration to aid in uniformly distributing the conditioned powder as a powder layer onto a substrate, wherein the conditioning means does not damage the powder. In one embodiment, the method may further include coupling the conditioning unit or conditioning means to the movable surface to subject the powder to conditioning prior to distribution of the conditioned powder as the powder layer onto the substrate. In certain embodiments, the method may further include coupling the conditioning unit or conditioning means to the funnel to subject the powder to conditioning prior to distribution of the powder across a surface of the movable surface. In some embodiments, the method may further include heating at least one of the funnel and the movable surface as a powder conditioning means to remove humidity from the ambient environment to increase fluidic flow of the powder. In one embodiment, the method may further include subjecting the powder placed in the funnel to at least one first conditioning means to condition the powder prior to distribution of the powder across a surface of the movable surface, and subjecting the conditioned powder distributed across a surface of the movable surface to at least one second conditioning means to uniformly distribute the conditioned powder as a powder layer onto a substrate, wherein the first condition means differs from the second conditioning means, and wherein the first and second conditioning means facilitate at least one of fluidic flow and preventing blockage, accumulation, and agglomeration of the powder without damaging the powder.

### Multiple Movable Surfaces With Gas Delivery System

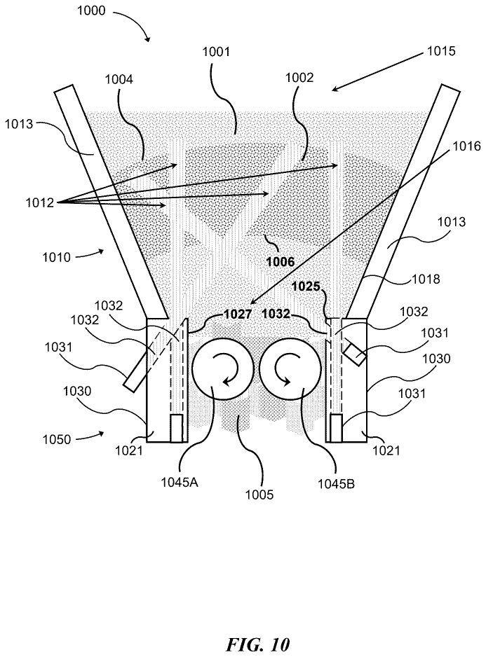

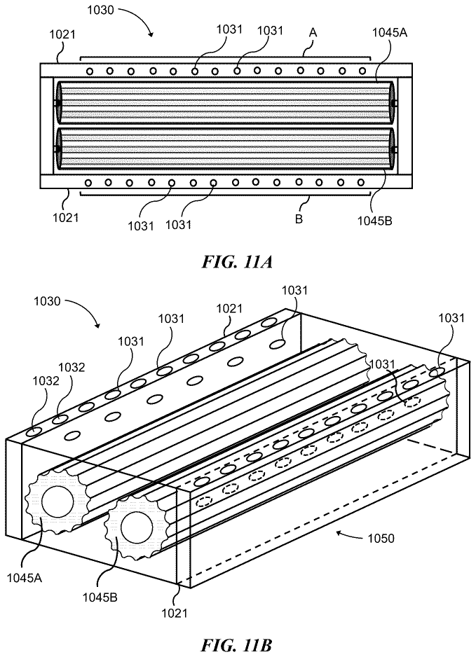

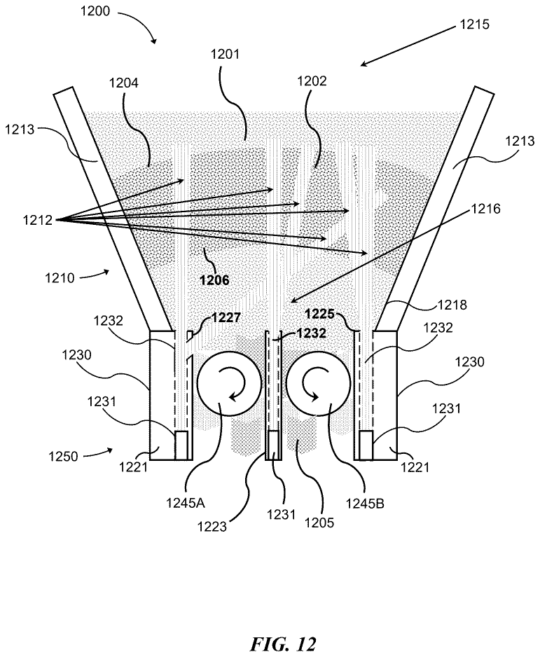

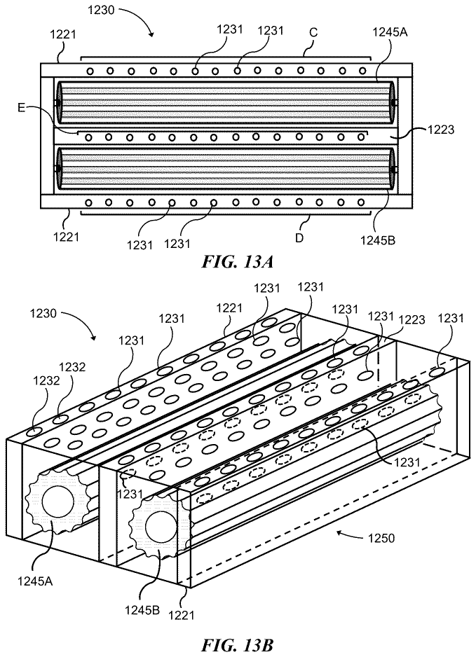

FIGS. 10 and 12 illustrate a cross-sectional side view of a powder distribution system configured to include multiple movable surfaces and a gas delivery system located within a conditioning unit. The conditioning unit configured to include an enclosure (e.g., a dispensing unit 140, or enclosure 150), the enclosure being attached to the outlet of a funnel of the powder distribution system. The enclosure being a part of the conditioning unit. In some embodiments, multiple movable surfaces and gas delivery devices may be mounted or removed from the conditioning unit (i.e., secured to an enclosure 1050/1250). With reference to FIGS. 11A-11B and 13A-13B plan and perspective views of a conditioning unit are illustrated and correspond to FIG. 10 and FIG. 12, respectively. In order to facilitate high line speeds (i.e., high powder spreading rates), a high powder deposition rate or high powder mass flow rate into the funnel of the powder distribution system is often needed. However, high powder deposition rate into the funnel can lead to powder build-up within the funnel due to the cohesiveness of powder 101 and accumulation of powder above the funnel outlet due to ambient environment and lower powder flow rate out of the funnel outlet. In particular, powder can accumulate (e.g., forming a bridge) above and across the outlet region of the funnel preventing further powder from going through the powder bridge and the outlet of the funnel. In some implementations, multiple movable surfaces and a gas delivery system may be implemented in the powder distribution system of FIG. 1 to fluidize powder above outlet region 116 and prevent powder bridging, for example. As described herein, one or more conditioning units may be attached (e.g., fixed, or detachably coupled) to an exterior surface of the funnel walls 113 to condition powder 101 (e.g., fluidize powder) and prevent powder bridging or accumulation within funnel 110. Moreover, as described herein, a plurality of movable surfaces 145 may be arranged side by side (and controlled separately) between the funnel walls 113 for moving powder 101 away from funnel 110. Further, as described herein, gas delivery (e.g., air jetting) may be applied before or after conditioning (e.g., mechanical/ultrasonic agitation, heating, etc. ,) to eliminate powder agglomeration at or near the outlet 116 of the funnel 110 as described and shown in FIGS. 3A-3H and FIG. 6.

With reference to FIGS. 10 and 11A-11B, a powder distribution system 1000 may be configured to include a funnel 1010 coupled to, or integrated with, a conditioning unit 1030 having an enclosure 1050. The conditioning unit 1030 may be configured to include a plurality of movable surfaces 1045A, 1045B and one or more gas delivery devices 1031 to fluidize powder 1001 and prevent powder accumulation, agglomeration, or bridging within the funnel 1010. In one embodiment, an apparatus containing multiple movable surfaces and a gas delivery system may be configured to be attached, or mounted, to a powder distribution system. In some implementations, a conditioning unit 1030 may include at least two movable surfaces 1045A, 1045B positioned between the exterior walls 1021 of the conditioning unit 1030 (i.e., the walls of the conditioning unit enclosure 1050). Further, the conditioning unit 1030 may include one or more gas delivery devices 1031 positioned between a movable surface 1045A/1045B and an exterior surface (e.g., an exterior wall 1021) of the conditioning unit 1030. The conditioning unit 1030 can include one or more ports 1032 (i.e., cavities) extending vertically within an exterior wall 1021 of the conditioning unit 1030. Each port 1032 can be configured to include a gas delivery device 1031. In one implementation, the gas delivery device 1031 is positioned within the port 1032 and configured to direct jets 1012 into the funnel 1010. In various implementations, the opening (e.g., diameter) of the one or more ports 1032 may be of the same size or different size. In some implementations, the top surface 1025 of one or more exterior walls 1021 may be configured to have an angle or slope that matches and aligns with the angle of the interior surface 1018 of the funnel wall 1013 thereby allowing ports 1032 to be positioned further into the outlet 1016 of the funnel 1010.

In a further aspect of the disclosure, a conditioning unit 1030 may be configured to include an array of gas delivery devices 1031 positioned adjacent to the movable surfaces 1045A, 1045B and an outlet 1016 of the funnel 1010. In various implementations, each gas delivery device 1031 of an array or plurality of gas jets may include a port 1032 for jetting air or gas at an angle into the outlet region 1016 and interior of the funnel 1010 to disrupt powder bridging 1002 and/or fluidize powder 1001 to move towards the outlet 1016. In certain implementations, the one or more gas delivery devices 1031 may be arranged and configured as needed to disrupt powder accumulation or powder bridging 1002 between the walls 1013 of the funnel 1010. In certain embodiments, the powder bridging 1002 may include an upper portion 1004 facing an inlet 1015 of the funnel 1010 and a lower portion 1006 facing the outlet 1016 of the funnel 1010. In some implementations, the port 1032 of each gas delivery device 1031 may be configured or angled as needed to direct jets 1012 of air or gas towards and through one or more regions of powder bridging 1002. In one embodiment, a plurality of lower portions 1006 of powder bridging 1002 may be applied with jets 1012 longitudinally across the funnel 1010 such that powder 1001 is dislodged from the powder bridging 1002 and caused to move within the funnel 1010 towards outlet 1016. In some implementations, the movable surfaces 1045A, 1045B may be positioned within the conditioning unit 1030 to facilitate sheer flow by sheering powder 1001 within the conditioning unit 1030 to form sheered powder 1005. In various implementations, the ports 1032 may be angled in a range of between −15° to +15° degrees from the normal to the top surface of the exterior wall 1021 of the conditioning unit 1030. In certain embodiments, the port 1032 above the gas delivery device 1031 may be angled with respect to the gas delivery device 1031. In some implementations, the gas delivery device 1031 and the port 1032 may be aligned and angled together. In some implementations, the exterior wall 1021 may include an exterior port 1032 extending laterally or vertically through the exterior wall 1021. Further, a gas delivery device 1031 may be coupled to, and detachable from, the exterior surface of the exterior wall 1021 to direct gas or air through the exterior port 1032. Further, in many embodiments, two or more movable surfaces 1045A, 1045B may be counter-rotating rollers with one or more grooves (e.g., splines), a roughened surface, a coated surface, or any combinations thereof. In certain embodiments, two or more movable surfaces 1045A, 1045B may be counter-rotating rollers with a smooth surface, one or more grooves (e.g., splines), a coated surface, or any combinations thereof. In various implementations, one or more ports 1032 may be positioned to cut through an interior surface 1027 of the exterior wall 1021. In some embodiments, one or more ports 1032 may form a cavity extending into an interior surface 1027 of the exterior wall 1021. In various implementations, one or more ports 1032 extending into the interior surface 1027 of the exterior wall 1021 may be configured to have an angle in a range of between −70° to +70° degrees from a normal to the interior surface 1027 of the exterior wall 1021. Moreover, a gas delivery device 1031 may be positioned within one or more ports 1032 to direct gas or air into the funnel from the interior surface 1027 of the exterior wall 1021.

With reference to FIGS. 11A-11B, in one implementation, the conditioning unit 1030 can include a plurality of gas delivery devices 1031 spaced apart and longitudinally positioned along one or more exterior walls 1021. In one embodiment, each gas delivery device 1031 may be equally spaced apart and arranged along a center of the exterior wall 1021. In some embodiments, the plurality of gas delivery devices 1031 may form a set A of gas delivery devices 1031 along the exterior wall 1021 and a set B of gas delivery devices 1031 along an opposite exterior wall 1021. Sets A and B of gas delivery devices 1031 may include one or more subsets of gas delivery devices 1031. In various implementations, each gas delivery device 1031 within a subset (i.e., each gas delivery device to gas delivery device pairing) may be spaced apart at the same or different spacings. Moreover, each gas delivery device 1031 (of set A or set B) may be configured to have an angle in a range of between −15° to +15° degrees from a normal to the top surface of the exterior wall 1021 of the conditioning unit 1030. In various implementations, each gas delivery device 1031 may be configured to be spaced 1-20 cm or more as needed based on the powder mass flow rate, volume of funnel, and volume of powder within the funnel. Moreover, each gas delivery device 1031 of the set B may be spaced apart individually at the same or different spacings as set A. The conditioning unit 1030 may be actuated (e.g., mechanical or ultrasonic), heated, or otherwise conditioned to fluidize powder 1001. In some implementations, each gas delivery device 1031 may be activated and remain activated based on the mass/volume of powder 1001 accumulated in the funnel 1010.

With reference to FIGS. 12 and 13A-13B, a powder distribution system 1200 may be configured to include a funnel 1210 coupled to, or integrated with, a conditioning unit 1230 having an enclosure 1250. The conditioning unit 1230 may be configured to include a plurality of movable surfaces 1245A, 1245B and one or more gas delivery devices 1231 to fluidize powder 1201 and prevent powder accumulation, agglomeration, or bridging within the funnel 1210. In one implementation, the conditioning unit 1230 may include one or more separators 1223 positioned between the exterior walls 1221 of the conditioning unit 1230 (i.e., the walls of the conditioning unit enclosure 1250) and the funnel walls 1213. In one embodiment, a separator 1223 may be positioned between two movable surfaces 1245A, 1245B. In certain embodiments, the geometry and dimensions of the separator 1223 may be adjusted to facilitate flow of powder 1201 to one or more movable surfaces 1245A, 1245B. In various implementations, one or more separators 1223 may be cylindrical shaped or rectangular shaped. Further, the one or more separators 1223 may have a height of 1.00-3.00 times the outer diameter (or thickness) of the corresponding or adjacent movable surface 1245A, 1245B. In some implementations, the one or more separators 1223 may have a height of 2.00-3.00 times or more of the outer diameter 191 of a corresponding or adjacent movable surface(s). In some implementations, the one or more separators 1223 may have a height extending into an upper portion 1204 of compacted powder 1201, In some implementations, the movable surfaces 1245A, 1245B may be positioned within the conditioning unit 1230 to facilitate sheer flow by sheering powder 1201 within the conditioning unit 1230 to form sheered powder 1205.

In many implementations, the separator 1223 may include a port 1232 (e.g., cavity) extending vertically within the separator 1223 of the conditioning unit 1230. Each port 1232 can be configured to include a gas delivery device 1231. In one implementation, the gas delivery device 1231 is positioned within the port 1232 and configured to direct jets 1212 into the funnel 1210. In certain embodiments, a separator 1223 may be configured to exclude a gas delivery device 1231. In various implementations, the opening (e.g., diameter) of the port 1232 within the separator 1223 may be of the same size or different size of other ports 1232 (e.g., on the exterior walls 1221) in the conditioning unit 1230. The plurality of ports 1232 and gas delivery devices 1231 may be configured to direct jets 1212 of air or gas to disrupt or prevent powder bridging 1202 above the outlet 1216 and between the walls 1213 of the funnel 1210. In various implementations, the ports 1232 may be angled in a range of between −45° to +45° degrees from the normal to the top surface of the separator 1223 or the exterior wall of the conditioning unit 1030. In various implementations, the separator 1223 may include one or more ports 1232 may be positioned to cut through each opposing exterior surface of the separator 1223. In some embodiments, one or more ports 1232 may form a cavity extending into the separator 1223 from each exterior surface. In various implementations, a port 1232 extending into the exterior surface of the separator 1223 may be configured to have an angle in a range of between −70° to +70° degrees from a normal to the exterior surface of the separator 1223. Moreover, a gas delivery device 1231 may be positioned within the port 1232 to direct gas or air into the funnel from the interior surface 1227 of the exterior wall 1221.

As described herein, powder bridging 1202 may include an upper portion 1204 of compacted powder 1201 facing an inlet 1215 of the funnel 1210 and prevent powder 1201 from flowing to the outlet 1216. The powder bridging 1202 may include a lower portion 1206 of compacted powder 1201 facing the outlet 1216 of the funnel 1210. In one implementation, the port 1232 of each gas delivery device 1231 may be configured or angled as needed to direct jets 1212 of air or gas longitudinally across the funnel 1210 and through one or more regions of powder bridging 1202. In one embodiment, a plurality of lower portions 1206 of powder bridging 1202 may be applied with jets 1212 such that powder 1201 is dislodged from the powder bridging 1202 and caused to move within the funnel 1210 towards outlet 1216. In some implementations, the top surface 1225 of one or more exterior walls 1221 may be configured to have an angle or slope that matches and aligns with the angle of the interior surface 1218 of the funnel wall 1213 thereby allowing ports 1232 to be positioned further into the outlet 1216 of the funnel 1210. In various implementations, one or more ports 1232 may be positioned to cut through an interior surface 1227 of the exterior wall 1221. In some embodiments, one or more ports 1232 may form a cavity extending into an interior surface 1227 of the exterior wall 1221. In various implementations, one or more ports 1232 extend into the interior surface 1227 of the exterior wall 1221. The one or more ports 1232 may be configured to route a portion of gas or air at an angle from the interior surface 1227 of the exterior wall 1221. The one or more ports 1232 may be configured to have an angle in a range of between −70° to +70° degrees from a normal to the interior surface 1227 of the exterior wall 1221.

In a further aspect of the disclosure, with reference to FIGS. 10 and 12, in many implementations any number and combination of ports 1032/1232, movable surfaces 1045A/1245A and 1045B/1245B, gas delivery devices 1031/1231, and separator walls 1223 may be arranged to form a conditioning unit (or positioned within an enclosure of the conditioning unit). In some embodiments, an enclosure 1050/1250 may include ports 1032/1232 formed through the exterior walls of the enclosure 1050/1250. In certain embodiments, an enclosure 1050/1250 may include ports 1032/1232 formed on one or more sidewalls of an exterior wall of the enclosure 1050/1250 and/or separator walls 1223 of the enclosure 1050/1250. Moreover, one or more intersecting ports (as shown in FIGS. 10 and 12) may be formed in the exterior wall(s) or separator(s) of the enclosure 1050/1250. In one embodiment, each intersecting port may include a gas delivery device positioned within the port. In some embodiments, an intersecting port may be configured to direct gas delivery from a gas delivery device 1031/1231 positioned in another port. In one embodiment, a port 1032/1232 may be formed to cut laterally/vertically through the exterior wall 1021/1221 to direct a gas delivery device 1231 communicably coupled to the exterior wall 1021/1221. In many embodiments, one or more ports 1032/1232 may extend (cut) partially into an exterior wall 1021/1221 of the enclosure 1050/1250. Further, in certain embodiments, one or more ports 1032/1232 may extend (cut) partially into separator walls 1223 of the enclosure 1050/1250. In some embodiments, one or more ports 1032/1232 may extend (cut) completely through an exterior wall 1021/1221 of the enclosure 1050/1250 and be coupled with a gas delivery device 1031/1231.

With reference to FIGS. 13A-13B, in one implementation, the conditioning unit 1230 may include a plurality of gas delivery devices 1231 spaced apart and longitudinally positioned along one or more exterior walls 1221 and one or more separators 1223. In one embodiment, each gas delivery device 1231 may be equally spaced apart and arranged along a center of the exterior wall 1221 and/or separator 1223. In some embodiments, the plurality of gas delivery devices 1231 may form a set C of gas delivery devices 1231 along the exterior wall 1221, a set D of gas delivery devices 1231 along an opposite exterior wall 1221, and a set E of gas delivery devices 1231 along a separator 1223. Sets C, D, and E of gas delivery devices 1231 may include one or more subsets of gas delivery devices 1231. In various implementations, each gas delivery device 1231 within a subset (i.e., each gas delivery device to gas delivery device pairing) may be spaced apart at the same or different spacings. Moreover, each gas delivery device 1231 (of set C, set D, or set E) may be configured to have an angle in a range of between −15° to +15° degrees from the normal to the top surface of the exterior wall 1221 of the conditioning unit 1230. In various implementations, each gas delivery device 1231 may be configured to be spaced 1-20 cm or more as needed based on the powder mass flow rate, volume of funnel, and volume of powder within the funnel. Moreover, each gas delivery device 1231 of the set C, D, or E may be spaced apart individually at the same or different spacings as another set. The conditioning unit 1230 may be actuated (e.g., mechanical or ultrasonic), heated, or otherwise conditioned to fluidize powder 1201. The conditioning unit 1230 may be actuated (e.g., mechanical or ultrasonic), heated, or otherwise conditioned to fluidize powder 1201. In some implementations, each gas delivery device 1231 may be activated and remain activated based on the mass/volume of powder 1201 accumulated in the funnel 1210. As an example, a first subset of gas delivery devices 1231 from the set C may include between 2-10 gas delivery devices spaced 1.00-10.00 cm apart, a second subset of gas delivery devices 1031 from the set D may include between 3-7 gas delivery devices spaced 3.00-15.00 cm apart, a third subset of gas delivery devices 1031 from the set E may include between 7-15 gas delivery devices spaced 5.00-20.00 cm apart, and so forth.

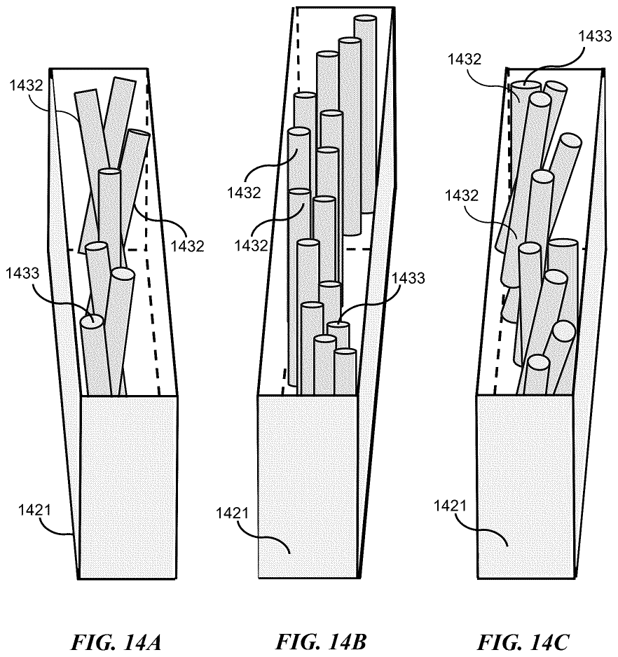

With reference to FIGS. 14A-14C, in various implementations, each port 1432 of a conditioning device as described herein may be configured to be at an angle (or no angle) to direct jets of air or gas into the funnel. The jets of air or gas can, for example, disrupt and/or prevent powder bridging to facilitate high line speeds (e.g., high powder spreading rates) from the outlet of the funnel and high powder deposition rate (e.g., high powder mass flow rate) of powder into the funnel. As is readily contemplated, any number of movable surfaces, separators, ports, and gas delivery devices may be implemented as needed to scale with various funnel sizes and desired powder deposition rates. Referring to FIG. 14A, in one implementation, a conditioning unit wall 1421 (e.g., exterior, interior, or separator wall) may include a plurality of ports 1432. In some implementations, each port 1432 may be configured as a cavity 1433 within the wall 1421 to direct jets of air or gas from a gas delivery device 1431 positioned within the wall 1421 or within the port 1432. Further, each port 1432 may be arranged longitudinally across the wall 1421 and arranged at various angles. Each port 1432 may be configured to direct jets of air or gas at different angles through an interior volume of a funnel to prevent powder accumulation, powder agglomeration, or powder bridging. Referring to FIG. 14B, in one implementation, a conditioning unit wall 1421 (e.g., exterior, interior, or separator wall) may include a plurality of ports 1432 arranged vertically for directing jets of air or gas from a gas delivery device. In some implementations, each port 1432 may be configured as a cavity 1433 within the wall 1421 to direct jets of air or gas from a gas delivery device 1431 positioned within the wall 1421 or within the port 1432. In some implementations, each port 1432 may be arranged in a curve or arc extending longitudinally across the wall 1421 and configured to direct jets of air or gas vertically through an interior volume of a funnel to prevent powder accumulation, powder agglomeration, or powder bridging. Referring to FIG. 14C, in one implementation, a conditioning unit wall 1421 (e.g., exterior, interior, or separator wall) may include a plurality of ports 1432 having different lengths, sizes, and angles. In some implementations, each port 1432 may be configured as a cavity 1433 within the wall 1421 to direct jets of air or gas from a gas delivery device 1431 positioned within the wall 1421 or within the port 1432. Each port 1432 may be arranged vertically, in an arc, and at angles longitudinally across the wall 1431 for directing jets of air or gas from a gas delivery device through an interior volume of a funnel to prevent powder accumulation, powder agglomeration, or powder bridging. As is readily contemplated, any combination of ports 1432 from FIGS. 14A-14C may be implemented within a powder distribution system and/or conditioning unit walls/separators as needed. For example, based on powder compositions, powder mass flow rate, and other parameters for actuating or agitating a region adjacent to the one or more movable surfaces one arrangement of ports 1432 may be preferable. Further, any combination of conditioning means may be applied, for example, gas delivery (e.g., air jetting), interior and ambient environment heating, interior fanning/movable surface(s) to fluidized powder, and ultrasonic actuation may be applied as described herein. In some implementations, the conditioning unit (or enclosure) wall 1421 containing gas delivery devices and ports for directing gas or air may be replaced/swapped with another wall 1421 containing a different configuration of ports and gas delivery devices.

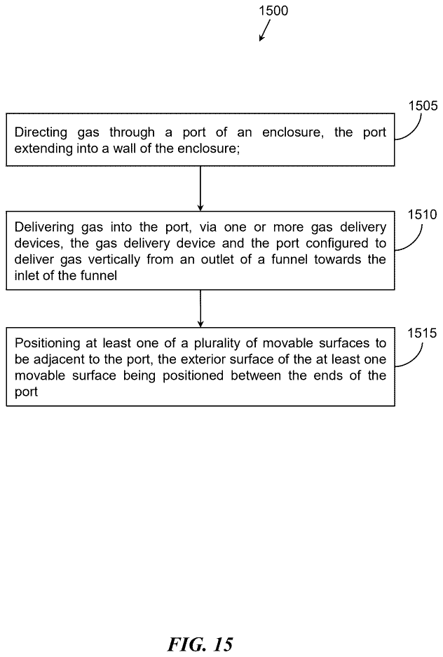

FIG. 15 illustrates an example flowchart depicting a process for implementing an apparatus with multiple movable surfaces with a gas delivery system to fluidize powder. These exemplary methods are provided by way of example, as there are a variety of ways to carry out these methods. Each block shown in FIG. 15 represents one or more processes, methods, or subroutines, carried out in the exemplary method. FIGS. 10-14C show example embodiments of carrying out the method of FIG. 15 for fluidizing powder within a funnel to facilitate high speed powder deposition (high line speeds) and uniform powder deposition while preventing powder bridging, accumulation, and agglomeration. Each block shown in FIG. 15 represents one or more processes, methods, or subroutines, carried out in the exemplary method. The exemplary method may begin at block 1505. Method 1500 may be used independently or in combination with other methods or process for facilitating high speed powder deposition (high line speeds) and uniform powder deposition while preventing powder bridging, accumulation, and agglomeration. For explanatory purposes, the example process 1500 is described herein with reference to the powder deposition system of FIGS. 10-14C. Further for explanatory purposes, the blocks of the example process 1500 are described herein as occurring in serial, or linearly. However, multiple blocks of the example process 1500 may occur in parallel. In addition, the blocks of the example process 1500 may be performed a different order than the order shown and/or one or more of the blocks of the example process 1500 may not be performed. Further, any or all blocks of example process 1500 may further be combined and done in parallel, in order, or out of order.

In FIG. 15, the exemplary method 1500 of facilitating high speed powder deposition (high line speeds) and uniform powder deposition while preventing powder bridging, accumulation, and agglomeration engineering is shown. Method 1500 begins at block 1505. In block 205, the method includes directing gas through a port of an enclosure, the port extending into a wall of the enclosure. In block 1510, the method includes delivering gas into the port, via one or more gas delivery devices, the gas delivery device and the port configured to deliver gas vertically from an outlet of a funnel towards the inlet of the funnel. In block 1515, the method includes positioning at least one of a plurality of movable surfaces to be adjacent to the port, the exterior surface of the at least one movable surface being positioned between the ends of the port.

It is noted that, although specific examples of processing steps for a 3D printing operation have been illustrated and discussed, the order of the processing steps could be changed, if desired, and/or additional processing steps could be added.

In the following, further features, characteristics, and advantages of the instant application will be described by means of items:
Item 1. An apparatus, comprising: a funnel, the funnel including at least one wall extending in a longitudinal direction; a movable surface, the movable surface positioned below the funnel and extending in the longitudinal direction beyond a distal end of the at least one wall; an exterior surface of the movable surface configured to include at least one groove; and wherein the funnel is centrally positioned between the distal ends of the movable surface to uniformly distribute powder placed in the funnel across a surface of the movable surface.
Item 2. The apparatus of claim 1, further comprising a conditioning means configured to subject the powder placed in the funnel to one or more conditioning to facilitate at least one of fluidic flow and preventing powder blockage to aid in uniformly distributing the powder, wherein the movable surface distributes the conditioned powder as a powder layer onto a substrate, and wherein the conditioning means does not damage the powder.
Item 3. The apparatus of claim 2, wherein the conditioning means is coupled to the movable surface to subject the powder to conditioning prior to distribution of the conditioned powder as the powder layer onto the substrate.
Item 4. The apparatus of claim 2, wherein the conditioning means is coupled to the funnel to subject the powder to conditioning prior to distribution of the powder across a surface of the movable surface.
Item 5. The apparatus of claim 2, further comprising a movable surface housing, the movable surface housing providing the conditioning means by confining and shearing the powder between at least two of: the movable surface housing, the exterior surface of the movable surface, and the at least one groove of the movable surface.
Item 6. The apparatus of claim 2, further comprising a mechanical actuation unit positioned in an interior space of the funnel, the mechanical actuation unit providing the conditioning means.
Item 7. The apparatus of claim 2, further comprising a mechanical actuation unit positioned on at least one of the funnel, the movable surface, and a movable surface housing, the mechanical actuation unit providing the conditioning means.
Item 8. The apparatus of claim 2, further comprising a heating unit positioned on at least one of an interior space of the funnel, an exterior space of the funnel, the funnel, the funnel, the movable surface, and a movable surface housing, the heating unit providing the conditioning means, and the heating unit configured to increase fluidic flow and prevent blockage of the powder.
Item 9. The apparatus of claim 1, wherein the at least one wall extends diagonally in a vertical direction.
Item 10. The apparatus of claim 1, wherein the movable surface is a rotatable shaft, and a shape of the exterior surface of the rotatable shaft is configured to facilitate uniform transfer of the powder away from the funnel, the shape being selected from the group consisting of a grooved wheel, a spline, a gear, and a smooth cylinder.
Item 11. A method, comprising: depositing powder into a funnel, the funnel including at least one wall extending in a longitudinal direction; receiving deposited powder placed in the funnel by a movable surface, the movable surface positioned below the funnel and extending in the longitudinal direction beyond a distal end of the at least one wall; uniformly distributing powder placed in the funnel across a surface of the movable surface; moving the movable surface to move the deposited powder in the funnel away from the at least one wall of the funnel; and wherein an exterior surface of the movable surface is configured to include at least one groove.
Item 12. The method of claim 11, further comprising subjecting the powder placed in the funnel to one or more conditioning to facilitate at least one of fluidic flow and preventing powder blockage to aid in uniformly distributing the conditioned powder as a powder layer onto a substrate, wherein the conditioning means does not damage the powder.
Item 13. The method of claim 12, further comprising coupling the conditioning means to the movable surface to subject the powder to conditioning prior to distribution of the conditioned powder as the powder layer onto the substrate.
Item 14. The method of claim 12, further comprising coupling the conditioning means to the funnel to subject the powder to conditioning prior to distribution of the powder across a surface of the movable surface.
Item 15. The method of claim 12, further comprising coupling a housing to the movable surface, the housing providing the conditioning means by confining and shearing the powder between at least two of: the movable surface housing, the exterior surface of the movable surface, and the at least one groove of the movable surface.
Item 16. The method of claim 12, further comprising actuating at least one of an interior space of the funnel, the funnel, the movable surface, and a movable surface housing as the conditioning means to aid in uniform distribution of powder, the direction of actuation being only either perpendicular or longitudinal to the movable surface.
Item 17. The method of claim 12, further comprising actuating at least one of an interior space of the funnel, the funnel, the movable surface, and a movable surface housing as the conditioning means to aid in uniform distribution of powder, the direction of actuation being only either perpendicular or longitudinal to the movable surface.
Item 18. The method of claim 12, further comprising heating at least one of an interior space of the funnel, an exterior space of the funnel, the funnel, the funnel, the movable surface, and a movable surface housing as the conditioning means to increase fluidic flow of the powder.
Item 19. The method of claim 12, further comprising subjecting the powder placed in the funnel to at least one first conditioning means to condition the powder prior to distribution of the powder across a surface of the movable surface, and subjecting the conditioned powder distributed across a surface of the movable surface to at least one second conditioning means to uniformly distribute the conditioned powder as a powder layer onto a substrate, wherein the first condition means differs from the second conditioning means, and wherein the first and second conditioning means facilitate at least one of fluidic flow and preventing powder blockage without damaging the powder.
Item 20. The method of claim 11, further comprising configuring a shape of the exterior surface of movable surface to facilitate uniform transfer of the powder away from the funnel, the shape being selected from the group consisting of a grooved wheel, a spline, a gear, and a smooth cylinder.
Item 21. A method of manufacturing dry powder having active material particles, comprising: mixing the active material particles with one or more conductive additives; mixing the active material particles with one or more binder materials; forming a coating on the active material particles comprising of binder materials and conductive additives; configuring binder material amounts to promote sufficient electrolyte penetration when the dry powder is subjected to compaction; and depositing the dry powder mixture into the conditioning funnel.
Item 22. The method of claim 21, wherein the active material particle comprises of 60-90% binder surface coverage.
Item 23. The method of claim 21, further comprising applying a lubrication agent to the dry powder active material particles.
Item 24. The method of claim 21, further comprising applying a shearing force to enable the binder material particles to adhere to the active material particle surface.
Item 25. The method of claim 21, wherein the binder material amount is between 0.5-5% to promote sufficient electrolyte penetration when the dry powder is subjected to compaction.
Item 26. The method of claim 21, wherein the binder material amount includes 0.5-12% polyvinylidene fluoride (PVDF).
Item 27. The method of claim 21, wherein the binder material includes a porous binder coating, the porous binder coating comprising a matrix of nano PVDF particles between 200-500 nm in diameter.
Item 28. The method of claim 27, further comprising applying a low shear force to the dry powder to cause the nano PVDF particles to adhere to the surface of active material particle and to each other to form a three-dimensional matrix of particles without complete deformation.
Item 29. The method of claim 21, wherein the active material particles include graphite mixed with a conductive additive including carbon.
Item 30. The method of claim 21, further comprising conditioning the dry powder in a conditioning funnel to maintain a balance between flowability and cohesiveness of the dry powder.
Item 31. An apparatus, comprising: a pair of movable surfaces, the pair of movable surfaces extending in the longitudinal direction, the pair of movable surfaces being positioned near an outlet of a funnel; and a gas delivery device positioned adjacent to an exterior surface of a movable surface of the pair of movable surfaces; wherein the pair of movable surfaces are configured to uniformly distribute powder placed in the funnel across a surface of the pair of movable surfaces; and wherein the gas delivery device is configured to deliver gas vertically from an outlet of the funnel towards an inlet of the funnel.
Item 32. The apparatus of claim 1, further comprising an enclosure, the enclosure configured to include one or more ports extending at an angle through a portion of an exterior wall of the enclosure, each port of the one or more ports configured for directing gas delivery from the gas delivery device.
Item 33. The apparatus of claim 2, further comprising a second gas delivery device, the gas delivery device positioned in a first port of the one or more ports and configured to direct gas at a first angle, the second gas delivery device positioned in a second port of the one or more ports and configured to direct gas at a second angle, the first angle being different from the second angle.
Item 34. The apparatus of claim 2, wherein the gas delivery device is positioned adjacent to one port of the one or more ports and configured to deliver gas through the port to an outlet of the funnel towards an inlet of the funnel.
Item 35. The apparatus of claim 2, wherein the enclosure is configured to secure, to the funnel, at least one of the pair of movable surfaces and the at least one gas delivery device.
Item 36. The apparatus of claim 4, wherein the gas delivery device is positioned to be adjacent to a first port of the one or more ports, and wherein a second port of the one or more ports intersects with the first port to direct gas delivery in a different direction from the first port.
Item 37. The apparatus of claim 1, further comprising a separator wall located between the pair of movable surfaces, the separator wall including a port, wherein an additional gas delivery device is positioned within the port for delivering gas vertically from the outlet of the funnel towards the inlet of the funnel.
Item 38. A method, comprising: directing gas through a port of an enclosure, the port extending into a wall of the enclosure; delivering gas into the port, via one or more gas delivery devices, the gas delivery device and the port configured to deliver gas vertically from an outlet of a funnel towards the inlet of the funnel; and positioning at least one of a plurality of movable surfaces to be adjacent to the port, the exterior surface of the at least one movable surface being positioned between the ends of the port.
Item 39. The method of claim 8, configuring at least one movable surface of the plurality of movable surfaces as a rotatable shaft, wherein a shape of the exterior surface of the rotatable shaft is configured to facilitate uniform transfer of powder away from the outlet of funnel, the shape being selected from the group consisting of a grooved wheel, a spline, a gear, a roughened surface, and a smooth cylinder.
Item 40. The method of claim 8, further comprising directing gas through a second port of the enclosure, the port extending in a first direction to direct gas in the first direction, the second port cutting into the port and directing gas in a second direction different from the first direction, wherein the first and second directions direct gas vertically from the outlet of the funnel towards an inlet of the funnel.
Item 41. The method of claim 8, further comprising positioning the enclosure to be adjacent to the outlet of the funnel.
Item 42. The method of claim 9, wherein the port extends in a non-vertical direction and tangential to the rotatable shaft.
Item 43. The method of claim 9, wherein the gas is directed in a non-vertical direction and tangential to the rotatable shaft.
Item 44. The method of claim 8, wherein the enclosure further comprises a separator wall located between the pair of movable surfaces of the plurality of movable surfaces, the separator wall including a port, and delivering gas, via an additional gas delivery device positioned within the port, vertically from the outlet of the funnel towards the inlet of the funnel.
Item 45. A conditioning unit, comprising: an enclosure having two opposing exterior walls; a gas delivery device positioned adjacent to an exterior wall; at least one exterior wall comprising a port, the port extending into a portion of the at least one exterior wall to direct gas or air from the gas delivery device; a pair of movable surfaces, the pair of movable surfaces extending in the longitudinal direction, the pair of movable surfaces being positioned between the two opposing exterior walls; wherein the pair of movable surfaces are configured to uniformly distribute powder placed across a surface of the pair of movable surfaces; and wherein the enclosure is positioned near an outlet of a funnel; and wherein the gas delivery device is configured to deliver gas vertically from the outlet of the funnel towards an inlet of the funnel.
Item 46. The conditioning unit of claim 15, wherein the gas delivery device is positioned within the port.
Item 47. The conditioning unit of claim 15, wherein the pair of movable surfaces are horizontally aligned and positioned between opposite ends of the port, wherein each movable surface of the pair of movable surfaces is a rotatable shaft, and a shape of the exterior surface of the rotatable shaft is configured to facilitate uniform transfer of powder away from the outlet of the funnel, the shape being selected from the group consisting of a grooved wheel, a spline, a gear, a roughened surface, and a smooth cylinder.
Item 48. The conditioning unit of claim 15, further comprising an additional gas delivery device positioned adjacent to the other exterior wall of the two opposing exterior walls.
Item 49. The conditioning unit of claim 15, wherein at least one of the two opposing exterior walls includes two ports, a first of the two ports extending in one direction and a second of the two ports cutting into the first port and directing gas delivery in a second direction different from the first direction, wherein the first and second directions direct gas vertically from the outlet of the funnel towards an inlet of the funnel.
Item 50. The conditioning unit of claim 15, further comprising a separator wall located between the pair of movable surfaces, the separator wall including a port, wherein an additional gas delivery device is positioned within the port for delivering gas vertically from the outlet of the funnel towards the inlet of the funnel.

### Definitions

A “feeder”, “hopper”, or “funnel” as used herein includes, but is not limited to, any container or structure having one or more openings for holding and dispensing material.

A “dry powder”, “dry powder material”, “dry powder electrode”, “dry powder anode”, “dry powder cathode”, “loose powder”, “loose dry powder”, “particle”, “particulate”, “powder material”, or “powder layer” as used herein includes, but is not limited to, any particle or particulate of a dry powder material, dry powder materials, or dry powder compositions that may be altered (e.g., mixed with one or more particles, binders, solvents, conductive additives, or active anode or cathode materials) and/or conditioned through one or more conditioning means to improve flowability, cohesion, and handleability, and are used herein interchangeably.

A “agitation”, “actuation”, or “vibration” as used herein includes, but is not limited to, any application of mechanical energy to a surface that can emit longitudinal, radial, or transverse waves to displace powder or material resting on the surface or impart energy to the powder or material to effectuate motion of the powder or material.

A “conditioning unit”, “conditioning unit enclosure”, or “enclosure” as used herein includes, but is not limited to, any housing or module that may be configured to house a conditioning device and attach the conditioning device to a funnel or powder distribution device. The terms “conditioning unit”, “enclosure”, and “conditioning unit enclosure” are used herein interchangeably.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

The term “within a proximity”, “a vicinity”, “within a vicinity”, “within a predetermined distance”, “predetermined width”, “predetermined height”, “predetermined length” and the like may be defined between about 0.1 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.1 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. An apparatus, comprising:
a pair of movable surfaces, the pair of movable surfaces extending in the longitudinal direction, the pair of movable surfaces being positioned near an outlet of a funnel; and
a gas delivery device positioned adjacent to an exterior surface of a movable surface of the pair of movable surfaces;
wherein the pair of movable surfaces are configured to uniformly distribute powder placed in the funnel across a surface of the pair of movable surfaces; and
wherein the gas delivery device is configured to deliver gas vertically from an outlet of the funnel towards an inlet of the funnel.

2. The apparatus of claim 1, further comprising an enclosure, the enclosure configured to include one or more ports extending at an angle through a portion of an exterior wall of the enclosure, each port of the one or more ports configured for directing gas delivery from the gas delivery device.

3. The apparatus of claim 2, further comprising a second gas delivery device, the gas delivery device positioned in a first port of the one or more ports and configured to direct gas at a first angle, the second gas delivery device positioned in a second port of the one or more ports and configured to direct gas at a second angle, the first angle being different from the second angle.

4. The apparatus of claim 2, wherein the gas delivery device is positioned adjacent to one port of the one or more ports and configured to deliver gas through the port to an outlet of the funnel towards an inlet of the funnel.

5. The apparatus of claim 2, wherein the enclosure is configured to secure, to the funnel, at least one of the pair of movable surfaces and the at least one gas delivery device.

6. The apparatus of claim 4, wherein the gas delivery device is positioned to be adjacent to a first port of the one or more ports, and wherein a second port of the one or more ports intersects with the first port to direct gas delivery in a different direction from the first port.

7. The apparatus of claim 1, further comprising a separator wall located between the pair of movable surfaces, the separator wall including a port, wherein an additional gas delivery device is positioned within the port for delivering gas vertically from the outlet of the funnel towards the inlet of the funnel.

8. A method, comprising:
directing gas through a port of an enclosure, the port extending into a wall of the enclosure;
delivering gas into the port, via one or more gas delivery devices, the gas delivery device and the port configured to deliver gas vertically from an outlet of a funnel towards the inlet of the funnel; and
positioning at least one of a plurality of movable surfaces to be adjacent to the port, the exterior surface of the at least one movable surface being positioned between the ends of the port.

9. The method of claim 8, configuring at least one movable surface of the plurality of movable surfaces as a rotatable shaft, wherein a shape of the exterior surface of the rotatable shaft is configured to facilitate uniform transfer of powder away from the outlet of funnel, the shape being selected from the group consisting of a grooved wheel, a spline, a gear, a roughened surface, and a smooth cylinder.

10. The method of claim 8, further comprising directing gas through a second port of the enclosure, the port extending in a first direction to direct gas in the first direction, the second port cutting into the port and directing gas in a second direction different from the first direction, wherein the first and second directions direct gas vertically from the outlet of the funnel towards an inlet of the funnel.

11. The method of claim 8, further comprising positioning the enclosure to be adjacent to the outlet of the funnel.

12. The method of claim 9, wherein the port extends in a non-vertical direction and tangential to the rotatable shaft.

13. The method of claim 9, wherein the gas is directed in a non-vertical direction and tangential to the rotatable shaft.

14. The method of claim 8, wherein the enclosure further comprises a separator wall located between the pair of movable surfaces of the plurality of movable surfaces, the separator wall including a port, and delivering gas, via an additional gas delivery device positioned within the port, vertically from the outlet of the funnel towards the inlet of the funnel.

15. A conditioning unit, comprising:
an enclosure having two opposing exterior walls;
a gas delivery device positioned adjacent to an exterior wall;
at least one exterior wall comprising a port, the port extending into a portion of the at least one exterior wall to direct gas or air from the gas delivery device;
a pair of movable surfaces, the pair of movable surfaces extending in the longitudinal direction, the pair of movable surfaces being positioned between the two opposing exterior walls;
wherein the pair of movable surfaces are configured to uniformly distribute powder placed across a surface of the pair of movable surfaces; and
wherein the enclosure is positioned near an outlet of a funnel; and
wherein the gas delivery device is configured to deliver gas vertically from the outlet of the funnel towards an inlet of the funnel.

16. The conditioning unit of claim 15, wherein the gas delivery device is positioned within the port.

17. The conditioning unit of claim 15, wherein the pair of movable surfaces are horizontally aligned and positioned between opposite ends of the port, wherein each movable surface of the pair of movable surfaces is a rotatable shaft, and a shape of the exterior surface of the rotatable shaft is configured to facilitate uniform transfer of powder away from the outlet of the funnel, the shape being selected from the group consisting of a grooved wheel, a spline, a gear, a roughened surface, and a smooth cylinder.

18. The conditioning unit of claim 15, further comprising an additional gas delivery device positioned adjacent to the other exterior wall of the two opposing exterior walls.

19. The conditioning unit of claim 15, wherein at least one of the two opposing exterior walls includes two ports, a first of the two ports extending in one direction and a second of the two ports cutting into the first port and directing gas delivery in a second direction different from the first direction, wherein the first and second directions direct gas vertically from the outlet of the funnel towards an inlet of the funnel.

20. The conditioning unit of claim 15, further comprising a separator wall located between the pair of movable surfaces, the separator wall including a port, wherein an additional gas delivery device is positioned within the port for delivering gas vertically from the outlet of the funnel towards the inlet of the funnel.
